(19) United States
(12) Patent Application Publication
(10) Pub. No.: US 2025/0171325 A1
(43) Pub. Date: May 29, 2025

(54) SULFIDE ELECTROLYTES AND EFFICIENT METHODS FOR MAKING THE SAME

(71) Applicant: Florida State University Research Foundation, Inc., Tallahassee, FL (US)

(72) Inventors: Ifeoluwa Peter Oyekunle, Tallahassee, FL (US); Erica Truong, Tallahassee, FL (US); Tej Prasad Poudel, Tallahassee, FL (US); Yan-Yan Hu, Tallahassee, FL (US)

(21) Appl. No.: 18/958,002

(22) Filed: Nov. 25, 2024

Related U.S. Application Data
(60) Provisional application No. 63/603,398, filed on Nov. 28, 2023.

(51) Int. Cl. C01D 15/04; H01M 10/0562

(52) U.S. Cl. CPC C01D 15/04; C01P 2002/72; C01P 2002/86; C01P 2004/03; C01P 2006/40; H01M 10/0562; H01M 2300/008

(57) ABSTRACT

In accordance with the purpose(s) of the present disclosure, as embodied and broadly described herein, the disclosure, in one aspect, relates to sulfide electrolytes and synthesis of sulfide oxide electrolytes. The electrolytes have the general formula AₐM_{b}S_{c}X_{d}, have good ionic conductivity, and can demonstrate good air and moisture stability. The electrolytes can be a component of different types of batteries. The process of synthesizing the electrolytes is efficient and can be done under moderate conditions, which are useful characteristics of synthesis for scaling-up production.

### CROSS-REFERENCE TO RELATED APPLICATIONS

This application claims the benefit of and priority to co-pending U.S. Provisional Patent Application No. 63/603,398, filed on Nov. 28, 2023, the contents of which is incorporated by reference herein in its entirety.

### STATEMENT REGARDING FEDERALLY SPONSORED RESEARCH OR DEVELOPMENT

This invention was made with Government support under contract DMR1847038, DMR1644779, and DMR2128556 awarded by the National Science Foundation. The Government has certain rights in the invention.

### BACKGROUND

The burgeoning interest towards sustainable and renewable energy has engendered a need to develop fast-ion conducting solid electrolytes to cater for the ever-increasing demand for smart battery systems and all-solid-state batteries. Organic electrolyte-based commercial batteries that currently dominate the global market suffer from several limitations closely linked with safety issues, therefore, solid state electrolytes with improved mechanical and chemical stability, high energy density, wide electrochemical window, and electrochemical stability have been poised as the next-generation energy storage material. In recent years, there has been an increase of interest in sulfide electrolytes. Broadly, the sulfide electrolytes families include Argyrodite (Li₆PS₅X), thio-LISICON, glassy sulfide, and LGPS (Li₁₀GeP₂S₁₂).

Ideally, a solid-state electrolyte should possess good mechanical property, low electronic conductivity, air and moisture stability, and high ionic conductivity. However, sulfide electrolytes suffer from poor air and moisture stability which limits their potential for wide scale application. In recent years, researchers have explored different routes to improve the moisture and chemical stability of sulfide electrolytes, for instance via atomic layer deposition of the electrolyte and elemental substitution based on hard-soft acid-base theory. This has led to considerable improvement but with an increase in overall cost, owing to the introduction of relatively expensive dopants. This, therefore, poses a need for discovery of air-stable sulfide electrolytes that do not require dopants for stability enhancement.

### SUMMARY

In accordance with the purpose(s) of the present disclosure, as embodied and broadly described herein, the disclosure, in one aspect, relates to sulfide electrolytes and synthesis of sulfide oxide electrolytes. The electrolytes have the general formula AₐM_{b}S_{c}X_{d}, have good ionic conductivity, and can demonstrate good air and moisture stability. The electrolytes can be a component of different types of batteries. The process of synthesizing the electrolytes is efficient and can be done under moderate conditions, which are useful characteristics of synthesis for scaling-up production.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows high-resolution X-ray diffraction (XRD) patterns and the corresponding Rietveld refinement of Li₄In₇S₁₂Cl (LISC).

FIGS. 1B-1D show different orientations of the cubic structure of LISC with Fd-3m space group obtained from the refined XRD pattern.

FIG. 2 shows a powder X-ray diffraction pattern of Li₄In₇S₁₂Cl and Li₄In₇S₁₂Br compared with ICSD patterns of precursors and other possible phases.

FIG. 3A shows high-resolution X-ray diffraction (XRD) patterns and the corresponding Rietveld refinement of Na₄In₇S₁₂Cl (NISC).

FIGS. 3B-3C show different orientations of the structure of NISC with Pbam space group obtained from the refined XRD pattern.

FIG. 4 shows a powder X-ray diffraction pattern of Na₄In₇S₁₂Cl compared with ICSD patterns of precursors and other possible phases.

FIG. 5A-5C show ⁷Li MAS variable-temperature (VT) NMR of LISC (FIG. 5A), ⁶Li MAS NMR spectra of LISC (FIG. 5B), and ²³Na MAS NMR spectra of NISC (FIG. 5C).

FIGS. 6A-6D show ion and electron transport properties of LISC, including: a Nyquist plot at 25° C. (FIG. 6A), an equivalent circuit fitting of a Nyquist plot at 0° C. (FIG. 6B), an Arrhenius plot and activation energy (FIG. 6C), and DC polarization and electronic conductivity (FIG. 6D).

FIGS. 7A-7D show ion and electron transport properties of NISC, including: an equivalent circuit fitting of a Nyquist plot at 25° C. (FIG. 7A), DC polarization and electronic conductivity (FIG. 7B), variable temperature Nyquist plots (FIG. 7C), and an Arrhenius plot and activation energy (FIG. 7D).

FIGS. 8A-8B show X-ray powder diffraction (FIG. 8A) and electrochemical impedance spectroscopy (FIG. 8B) of pristine LISC and humid-air exposed LISC.

FIG. 8C shows a chemical stability plot of LISC pellet measured over a period of 10 days in storage without air exposure.

FIG. 8D shows a Nyquist plot of LISC pellet measured over a period of 10 days after storage without air exposure.

FIG. 9 shows electrochemical impedance spectroscopy of LISC at longer ball-milling time.

FIGS. 10A-10D show (a) powder X-ray diffraction patterns of the nominal Li₄In₇S₁₂Cl and the precursors. ICSD patterns of Li₄In₇S₁₆Sn₂ and LiInS₂ are also shown as references; (b) high-resolution X-ray diffraction pattern and the corresponding Rietveld refinement of the nominal Li₄In₇S₁₂Cl, identifying the primary phase composition as Li₉In_{17.5}S_{29.5}Cl_{2.5}, which is used instead of Li₄In₇S₁₂Cl hereafter; (c) and (d) the structure of Li₉In_{17.5}S_{29.5}Cl_{2.5} with Fd-3m space group obtained from the refinement of the high-resolution XRD pattern and viewed from different angles.

FIGS. 11A-11B show (a) ⁶Li NMR spectra with resonance assignment. ⁶Li spectra of LiCl and Li₂S are shown as references and (b) ⁷Li T₁ NMR relaxation times of Li₈In_{17.5}S_{29.5}Cl_{2.5} as a function of temperature.

FIGS. 12A-12D show (a) Nyquist plot at 25° C. for Li₉In_{17.5}S_{29.5}Cl_{2.5}; (b) Nyquist plot at 0° C. with equivalent circuit fitting (inset) for Li₉In_{17.5}S_{29.5}Cl_{2.5}; (c) Arrhenius plot and the extracted activation energy (Ea) for ion transport in Li₉In_{17.5}S_{29.5}Cl_{2.5}, and (d) DC polarization curve of Li₉In_{17.5}S_{29.5}Cl_{2.5} for the cell set up SS|SE|SS for determining the electronic conductivity of the SE, Li₉In_{17.5}S_{29.5}Cl_{2.5}.

FIGS. 13A-13B show (a) mean square displacements of Li⁺ in Li₉In_{17.5}S_{29.5}Cl_{2.5} generated from AIMD simulations at 900 K and (b) Li⁺ (yellow) probability density distribution in Li₉In_{17.5}S_{29.5}Cl_{2.5} in a 1×1×1 supercell based on the AIMD simulations at 900 K.

FIGS. 14A-14D show (a) Nyquist plot for the as-prepared, exposed, and dried Li₉In_{17.5}S_{29.5}Cl_{2.5}; (b) Arrhenius plot and the extracted activation energy (Ea) for ion transport in as-prepared and moisture-exposed Li₉In_{17.5}S_{29.5}Cl_{2.5}; (c) SXRD patterns for as-prepared and moisture-exposed Li₉In_{17.5}S_{29.5}Cl_{2.5}; and (d) ⁶Li MAS NMR spectra of moisture-exposed and dried Li₉In_{17.5}S_{29.5}Cl_{2.5}.

FIGS. 15A-15B show SEM images and EDS elemental mapping of In, S, Cl, and O for (a) as-prepared and (b) moisture-exposed Li₉In_{17.5}S_{29.5}Cl_{2.5}.

FIGS. 16A-16B show SEM image and EDS elemental mapping of In, S, CI, and O for the (a) surface (b) cross-section of Li₉I_{17.5}S_{29.5}Cl_{2.5} pellet dried at 150° C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Sulfide Electrolytes and Methods of Making and Using the Same

The present disclosure provides for sulfide electrolytes and the method of making and using sulfide electrolytes. The electrolytes have the general formula AₐM_{b}S_{c}X_{d}, have good ionic conductivity, and can demonstrate good air and moisture stability. The electrolytes can be a component of different types of batteries, such as solid-state batteries. The process of synthesizing the electrolytes is efficient and can be done under moderate conditions, which are useful characteristics for scaling-up production.

In one aspect, the electrolytes have the formula AₐM_{b}S_{c}X_{d}, where A can be Li, Na, K, or any combination thereof; M can be Al, Ga, In, or any combination thereof; X can be CI, Br, I, or any combination thereof; and S is sulfur. Furthermore, a can be from about 3 to about 15 or about 3, 4, 4, 6, 7, 8, 9, 10, 11, 12, 13, 14, or 15, where any value can be a lower and upper endpoint of a range (e.g., 5 to 12); b can be from about 6 to about 20 or about 6, 7, 8, 9, 10, 11, 12, 13, 14, 15, 16, 17, 18, 19, or 20, where any value can be a lower and upper endpoint of a range (e.g., 10 to 15); c can from about 11 to about 35 or about 11, 13, 15, 17, 19, 21, 23, 25, 27, 29, 31, 33, or 35 where any value can be a lower and upper endpoint of a range (e.g., 13 to 21); d can be from about 0.5 to about 4.0 or about 0.5, 1.0, 1.5, 2.0, 2.5, 3.0, 3.5, or 4.0, where any value can be a lower and upper endpoint of a range (e.g., 1.0 to 2.5). In other aspects, a can be about 4. In other aspects, b can be about 7. In other aspects, c can be about 12. In still other aspects, d can be about 1.0.

In one aspect, the compound is AₐIn_{b}S_{c}X_{d}, wherein A is Li or Na, a is from 3 to 5, b is from 5 to 9, c is from 11 to 13, X is Cl or Br, and d is from 0.5 to 2. In another aspect, the compound is LiₐIn_{b}S_{c}Cl_{d}, wherein a is from 10 to 12, b is from 15 to 20, c is from 28 to 32, and d is from 2 to 3. In another aspect, the compound is one of Li₄In₇S₁₂Cl, Li₄In₇S₁₂Br, Na₄In₇S₁₂Cl, or Li₉In_{17.5}S_{29.5}Cl_{2.5}.

The electrolytes disclosed herein have several desirable properties. In one aspect, the electrolytes can have good ionic conductivity. The electrolytes can have an ionic conductivity of at least about 0.50 mS/cm, at least about 0.60 mS/cm, at least about 0.80 mS/cm, or at least about 1.00 mS/cm. In other aspects, the ionic conductivity of the electrolytes can be from about 0.50 mS/cm to about 2.50 mS/cm, or about 0.50 mS/cm, 1.00 mS/cm, 1.50 mS/cm, 2.00 mS/cm, or 2.50 mS/cm, where any value can be a lower and upper endpoint of a range (e.g., 1.50 mS/cm to 2.50 mS/cm). In some aspects, the ionic conductivity can increase when the electrolyte is exposed to humid air or water. The electrolytes can have an ionic conductivity of at least about 3.50 mS/cm, at least about 4.00 mS/cm, at least about 4.50 mS/cm, at least about 5.00 mS/cm, or at least about 5.50 mS/cm when exposed to humid air. In other aspects, the electrolytes, when exposed to humid air, can have an ionic conductivity from about 4.00 mS/cm to about 6.00 mS/cm or about 4.00 mS/cm, about 4.50 mS/cm, about 5.00 mS/cm, about 5.50 mS/cm, or about 6.00 mS/cm, where any value can be a lower and upper endpoint of a range (e.g., 4.50 mS/cm to 5.50 mS/cm). In other aspects, the electrolytes can have an electronic conductivity of less than about 1.00×10⁻⁷ S/cm, less than about 8.00×10⁻⁸ S/cm, or less than about 8.00×10⁻⁹ S/cm. In other aspects, the electrolytes can have an electronic conductivity of about 1.00×10⁻⁷ S/cm to about 1.00×10⁻¹⁰ S/cm or about 1.00×10⁻⁷ S/cm, 1.00×10⁻⁸ S/cm, 1.00×10⁻⁹ S/cm, or 1.00×10⁻¹⁰ S/cm, where any value can be a lower and upper endpoint of a range (e.g., 1.00×10⁻⁷ S/cm to 1.00×10⁻⁸ S/cm). The electrolytes can be conductive over a temperature range of about −20° C. to about 100° C. Exemplary methods for determining ionic conductivity and electronic conductivity are provided in the Examples.

Humid air can be defined as air at about 35% relative humidity and 25° C. In other aspects, humid air can comprise a relative humidity of about 30% to about 50%, or 30%, 35%, 40%, 45%, or 50%, where any value can be a lower and upper endpoint of a range (e.g., 40% to 45%), at temperatures of about 20° C. to about 30° C., or 20° C., 22° C., 25° C., 28° C., or 30° C., where any value can be a lower and upper endpoint of a range (e.g., 22° C. to 28° C.). In other aspects, humid air can be defined by the grams of H₂O per kg of air, such as about 6.9 g/kg. In further aspects, humid air, measured as the grams of H₂O per kg of air, can be about 4.0 g/kg to about 14.0 g/kg or 4.0 g/kg, 6.0 g/kg, 8.0 g/kg, 10.0 g/kg, 12.0 g/kg, or 14.0 g/kg, where any value can be a lower and upper endpoint of a range (e.g., 4.0 g/kg to 8.0 g/kg).

In some aspects, the structure of the electrolytes can be a cubic structure in the Fd-3m space group. In other aspects, the electrolytes can have an orthorhombic structure in the Pbam space group.

The electrolytes described herein have unique X-ray diffraction (XRD) patterns. In some aspects, XRD measurements of the electrolytes are performed using an X-ray wavelength of 0.24 Å or 0.24117 Å. The electrolytes can have an X-ray powder diffraction pattern including peaks at 27.3°, 33.1°, and 47.6°±0.2° 2θ as measured by X-ray powder diffraction using an X-ray wavelength of 0.24117 Å. In further other aspects, the electrolytes can have an X-ray powder diffraction pattern including peaks at 27.3°, 33.1°, 43.5°, and 47.6°±0.2° 2θ as measured by X-ray powder diffraction using an X-ray wavelength of 0.24117 Å. In other aspects, the electrolytes can have an X-ray powder diffraction pattern including peaks at 32.3°, 33.7°, 46.6°, and 47.8°±0.2° 2θ as measured by X-ray powder diffraction using an X-ray wavelength of 0.24117 Å.

Additionally, the electrolytes described herein possess unique solid-state NMR spectra. In one aspect, the Li-containing electrolytes can have peaks at about 0.17 ppm, 1.49 ppm, and 2.03 ppm as determined by 6Li solid-state NMR spectroscopy. In another aspect, the Na-containing electrolytes can have peaks at about 6.14 ppm, 7.25 ppm, and 11.69 ppm as determined by 23Na solid-state NMR spectroscopy. In some aspects, the Na-containing electrolytes can have additional peaks at 0.04 ppm and 0.67 ppm as determined by 23Na solid-state NMR spectroscopy. Exemplary methods for performing XRD and NMR measurements are provided in the Examples.

Also disclosed is a method for making sulfide electrolytes having the formula AₐM_{b}S_{c}X_{d}, where A can be Li, Na, K, or any combination thereof; M can be Al, Ga, In, or any combination thereof; X can be Cl, Br, I, or any combination thereof; and S is sulfur. Furthermore, a can be from about 3 to about 15 or about 3, 4, 4, 6, 7, 8, 9, 10, 11, 12, 13, 14, or 15, where any value can be a lower and upper endpoint of a range (e.g., 5 to 12); b can be from about 6 to about 20 or about 6, 7, 8, 9, 10, 11, 12, 13, 14, 15, 16, 17, 18, 19, or 20, where any value can be a lower and upper endpoint of a range (e.g., 10 to 15); c can from about 11 to about 35 or about 11, 13, 15, 17, 19, 21, 23, 25, 27, 29, 31, 33, or 35 where any value can be a lower and upper endpoint of a range (e.g., 13 to 21); d can be from about 0.5 to about 4.0 or about 0.5, 1.0, 1.5, 2.0, 2.5, 3.0, 3.5, or 4.0, where any value can be a lower and upper endpoint of a range (e.g., 1.0 to 2.5).

The method includes mixing a plurality of precursor compounds, such as salts, in various amounts in the solid state and heating the mixture to produce the electrolytes. In one aspect, the compounds are mixed together in stoichiometric amounts. The compounds mixed together can include A₂S, M₂S₃, AX, and any combination thereof, to produce a first mixture. In some aspects, the compounds mixed together include A₂S, selected from the group consisting of Li₂S, Na₂S, and a combination thereof; In₂S₃; and AX, selected from the group consisting of LiCl, LiBr, NaCl, NaBr, and a combination thereof.

The compounds used to produce the electrolytes described herein are generally highly pure materials. In one aspect, each of the compounds has a purity of greater than 99%, greater than 99.5%, or greater than 99.9%. In one aspect, each compound used to produce the electrolytes are substantially anhydrous, where each compound is at least 95% moisture free, at least 98% moisture free, at least 99% moisture free, at least 99.9% moisture free, or 100% moisture free. In another aspect, each compound has less than 0.5 ppm water, less than 0.25 ppm water, or less than 0.1 ppm water.

In another aspect, the compounds can be mixed by mechanochemical milling. Mixing of the compounds can occur in a mixing jar or container using one or more balls to produce a complex motion that combines back-and-forth swings with short lateral movements. In one aspect, the compounds are mixed with one another for at least seven hours, less than seven hours, or less than 5 hours. In another aspect, the compounds are mixed from about 3 hours to about 7 hours or about 3 hours, 4 hours, 5 hours, 6 hours or 7 hours, where any value can be a lower and upper endpoint of a range (e.g., 4 hours to 6 hours.). In one aspect, the compounds are mixed in an inert atmosphere such as, for example, nitrogen or argon. In one aspect, the inert atmosphere has less than 0.5 ppm oxygen, less than 0.25 ppm oxygen, or less than 0.1 ppm oxygen. In some aspects, the mixture is further dried after mixing. After mixing, the mixture can be pelletized. The pellets or mixture can be heat treated at temperatures of about 300° C. to about 700° C. or 300° C., 400° C., 500° C., 600° C., or 700° C., where any value can be a lower and upper endpoint of a range (e.g., 300° C. to 600° C.). The heat treatment can be from about 10 hours to about 20 hours or 10 hours, 12 hours, 14 hours, 15 hours, 16 hours, 18 hours, or 20 hours, where any value can be a lower and upper endpoint of a range (e.g., 14 hours to 16 hours). In other aspects, the pellets or mixture can be heat treated at temperatures of about 500° C. for about 15 hours.

The compounds described herein may include small amounts of impurities. In one aspect, the impurity may be LiInS₂. In one aspect, the compounds described herein consists essentially of AₐM_{b}S_{c}X_{d}, where the compound includes at most 10 weight percent impurity such as, for example, LiInS₂.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

Aspect 1. A compound having the formula AₐM_{b}S_{c}X_{d}, wherein
A is Li, Na, K, or any combination thereof;
M is Al, Ga, In, or any combination thereof;
X is CI, Br, I, or any combination thereof;
S is sulfur;
a is from about 3 to about 15;
b is from about 6 to about 20;
c is from about 11 to about 35; and
d is from about 0.5 to about 4.

Aspect 2. The compound of Aspect 1, wherein A is Li.

Aspect 3. The compound of Aspect 1, wherein A is Na.

Aspect 4. The compound of any one of Aspects 1-3, wherein a is about 4.

Aspect 5. The compound any one of Aspects 1-4, wherein M is Al.

Aspect 6. The compound of any one of Aspects 1-4, wherein M is Ga.

Aspect 7. The compound of any one of Aspects 1-4, wherein M is In.

Aspect 8. The compound of any one of Aspects 1-7, wherein b is about 7.

Aspect 9. The compound of any one of Aspects 1-8, wherein c is about 12.

Aspect 10. The compound of any one of Aspects 1-9, wherein X is Cl or Br.

Aspect 11. The compound of any one of Aspects 1-10, wherein d is about 1.0.

Aspect 12. The compound of Aspect 1, wherein A is Li or Na, M is In, and X is Cl or Br.

Aspect 13. The compound of Aspect 1, wherein A is Li, M is In, and X is Cl or Br.

Aspect 14. The compound of Aspect 1, wherein A is Na, M is In, and X is Cl or Br.

Aspect 15. The compound of Aspect 1, wherein (1) a is from 3 to 5, b is from 5 to 9, c is from 11 to 13, and d is from 0.5 to 2 or (2) a is from 10 to 12, b is from 15 to 20, c is from 28 to 32, and d is from 2 to 3.

Aspect 16. The compound of Aspect 1, wherein the compound is AₐIn_{b}S_{c}X_{d}, wherein A is Li or Na, a is from 3 to 5, b is from 5 to 9, c is from 11 to 13, X is Cl or Br, and d is from 0.5 to 2.

Aspect 17. The compound of Aspect 1, wherein the compound is LiₐIn_{b}S_{c}Cl_{d}, wherein a is from 10 to 12, b is from 15 to 20, c is from 28 to 32, and d is from 2 to 3.

Aspect 18. The compound of Aspect 1, wherein the compound is one of Li₄In₇S₁₂Cl, Li₄In₇S₁₂Br, Na₄In₇S₁₂Cl, or Li₉In_{17.5}S_{29.5}Cl_{2.5}.

Aspect 19. The compound of any one of Aspects 1-18, wherein the compound has an ionic conductivity of at least 0.50 mS/cm.

Aspect 20. The compound of any one of Aspects 1-18, wherein the compound has an ionic conductivity of at least 1.00 mS/cm.

Aspect 21. The compound of any one of Aspects 1-18, wherein the compound has an ionic conductivity of at least 0.50 mS/cm to about 2.50 mS/cm.

Aspect 22. The compound any one of Aspects 1-18, wherein compound has an ionic conductivity of at least 4.00 mS/cm when exposed to humid air.

Aspect 23. The compound of any one of Aspects 1-18, wherein the compound has an ionic conductivity of at least 4.00 mS/cm to about 6.00 mS/cm when exposed to humid air.

Aspect 24. The compound of any one of Aspects 1-23, wherein the compound has an electronic conductivity less than 1.00×10⁻⁷ S/cm.

Aspect 25. The compound of any one of Aspects 1-23, wherein the compound has an electronic conductivity of about 1.00×10⁻⁷ S/cm to about 1.00×10⁻¹⁰ S/cm.

Aspect 26. The compound of any one of Aspects 1-25, wherein the compound is conductive over a temperature range of about −20° C. to about 100° C.

Aspect 27. The compound of any one of Aspects 1-26, wherein the compound has a cubic structure in the Fd-3m space group.

Aspect 28. The compound of any one of Aspects 1-27, wherein the compound has an X-ray powder diffraction pattern comprising peaks at 27.3°, 33.1°, 43.5°, and 47.6°±0.2° 2θ as measured by X-ray powder diffraction using an X-ray wavelength of 0.24117 Å.

Aspect 29. The compound of any one of Aspects 1-27, wherein the compound has an X-ray powder diffraction pattern comprising peaks at 32.3°, 33.7°, 46.6°, and 47.8°±0.2° 2θ as measured by X-ray powder diffraction using an X-ray wavelength of 0.24117 Å.

Aspect 30. The compound of any one of Aspects 1-28, wherein the compound has peaks at about 0.17 ppm, 1.49 ppm, and 2.03 ppm as determined by 6Li solid-state NMR spectroscopy.

Aspect 31. The compound of any one of Aspects 1-28, wherein the compound has an orthorhombic structure in the Pbam space group.

Aspect 32. The compound of any one of Aspects 1-31, wherein the compound has peaks at about 6.14 ppm, 7.25 ppm, and 11.69 ppm as determined by 23Na solid-state NMR spectroscopy.

Aspect 33. The compound of any one of Aspects 1-32, wherein when the compound is exposed to moisture, the compound has an ionic conductivity that is greater to the ionic conductivity of the same compound that has not been exposed to moisture.

Aspect 34. A method for making a compound having the formula AₐM_{b}S_{c}X_{d}, wherein
A is Li, Na, K, or any combination thereof;
   M is Al, Ga, In, or any combination thereof;
   X is Cl, Br, I, or any combination thereof;
   S is sulfur;
   a is from about 3 to about 15;
   b is from about 6 to about 20;
   c is from about 11 to about 35; and
   d is from about 0.5 to about 4;
the method comprising:
(a) mixing in the solid state A₂S, M₂S₃, AX, and any combination thereof to produce a first mixture; and
(b) heating the first mixture to produce the compound.

Aspect 35. The method of Aspect 34, wherein A₂S, M₂S₃, and AX are substantially anhydrous.

Aspect 36. The method of Aspect 34 or Aspect 35, wherein A₂S, M₂S₃, and AX are mixed by mechanochemical milling.

Aspect 37. The method of any one of Aspects 34-36, wherein A₂S, M₂S₃, and AX are mixed in an inert atmosphere.

Aspect 38. The method of any one of Aspects 34-36, wherein A₂S, M₂S₃, and AX are mixed in stoichiometric amounts.

Aspect 39. The method of any one of Aspects 34-38, wherein the first mixture is produced by mixing A₂S, selected from the group consisting of Li₂S, Na₂S, and a combination thereof; In₂S₃; and AX, selected from the group consisting of LiCl, LiBr, NaCl, NaBr, and any combination thereof.

Aspect 40. The method of any one of Aspects 34-38, wherein the first mixture is heated at a temperature of from about 300° C. to about 700° C.

Aspect 41. The method of any one of Aspects 34-38, wherein the first mixture is heated at a temperature of from about 400° C. to about 600° C.

Aspect 42. The method of any one of Aspects 34-41, wherein the first mixture is heated from about 10 hours to about 20 hours.

Aspect 43. A compound produced by the method of any one of Aspects 34-42.

Aspect 44. A battery comprising the compound in any one of Aspects 1-33 and 43.

Aspect 45. The battery of Aspect 44, wherein the battery is a solid-state battery.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Example 1

### Materials and Methods

Material Synthesis—LiCl (Sigma Aldrich) and LiBr (Sigma Aldrich) were dried under vacuum at 200° C. for 12 hours prior to synthesis. Li₂S (Alfa Aesar) and In₂S₃ (Sigma Aldrich) were received and used without further purification. Stoichiometric amounts of Li₂S, In₂S₃, LiCl/LiBr were ground using an agate mortar and pestle in a Li:In:S:Cl ratio 4:7:12:1 for 5 minutes. After grinding, the hand milled powder was transferred into a ZrO₂ jar containing two 10-mm balls as grinding aid. Mechanochemical mixing of the hand milled powder in a ZrO₂ jar sealed under vacuum was performed using a SPEX® 8000M MIXER/MILL® high energy ball mill (SPEX® SamplePrep, USA) for 5 hours. Afterwards, the ball milled powder, typically 100 mg-200 mg, was pressed into a 6-mm pellet under a pressure of ˜400 MPa inside an Argon-protected glovebox. The pellet was transferred into a quartz tube and sintered at 500° C. for 15 hours (ramping rate of 5° C./min) followed by natural cooling under Argon. The resulting pellet after sintering had a thickness varying from ˜1 mm to 2 mm and the pellet appeared as light yellow.

Powder X-ray Diffraction—The sintered pellet was finely grounded and packed in a zero—background sample holder. KAPTON® film (DUPONT™, USA) was used to seal the samples to prevent exposure to humid air. XRD was performed using a RIGAKUR D8 powder diffractometer with Bragg-Brentano geometry at a voltage of 45 kV and current of 40 mA with Cu—Ka radiation (a=1.5406 Å). The data was collected from 10-80 2θ at a step size of 0.03 for 30 minutes.

Solid-state NMR—⁶Li and ⁷Li NMR experiments were performed using a Bruker Avance-III 500 spectrometer at Larmor frequencies of 73.6 MHz and 194.4 MHZ, respectively. The MAS rate was 25 kHz. For ⁶Li and ⁷Li, single-pulse NMR experiments were performed using TT/2 pulse lengths of 3.30 μs and 2.90 μs, respectively. The recycle delays were 1000 s for ⁶Li and 80 s for ⁷Li. ^{6.7}Li NMR spectra were calibrated to LiCl₍₆₎ at −1.1 ppm. ⁷Li T₁ relaxation time was measured with an inversion-recovery pulse sequence. Variable-temperature in-situ 7Li NMR experiments were performed using a Bruker Avance III 300 spectrometer at Larmor frequency of 116.6 MHz from 298 to 343 K. ²³Na NMR experiments were performed using a Bruker Avance-III 500 spectrometer at a Larmor frequency of 132.3 MHz. The MAS rate was 25 kHz. For ²³Na, single-pulse NMR experiments were performed using a TT/2 pulse length of 3.7 μs and recycle delay of 50 s. A 0.1 M NaCl solution was used as the calibration standard at 0 ppm.

Synchrotron X-ray Diffraction—Synchrotron X-ray diffraction (XRD) measurement was carried out in capillary transmission mode at beamline APS@ANL, 17-BM-B at the Argonne National Lab, Illinois (ANL). The exact X-ray wavelength was refined to 0.24117 A. The sample was loaded inside a special glass capillary and the holder moves up and down during tests to ensure uniformity of measured results. Rietveld refinement of the XRD data was performed using GSAS-II.

Electrochemical Impedance Spectroscopy (EIS)—The sintered pellets were sandwiched between indium foils in a 6 mm cylindrical cell and the potentiostatic EIS measurement was performed using Gamry electrochemical analyzer. The ionic conductivity was determined using the resultant impedance from the equivalent circuit fitting of the Nyquist plots. Biologic SP-300 was utilized for variable temperature EIS (VT-EIS) measurement in the CSZ microclimate chamber. The activation energy of was calculated from the Arrhenius-type plots of the VT-EIS measurement. Electronic conductivity was measured using the DC polarization method.

### Results and Discussion

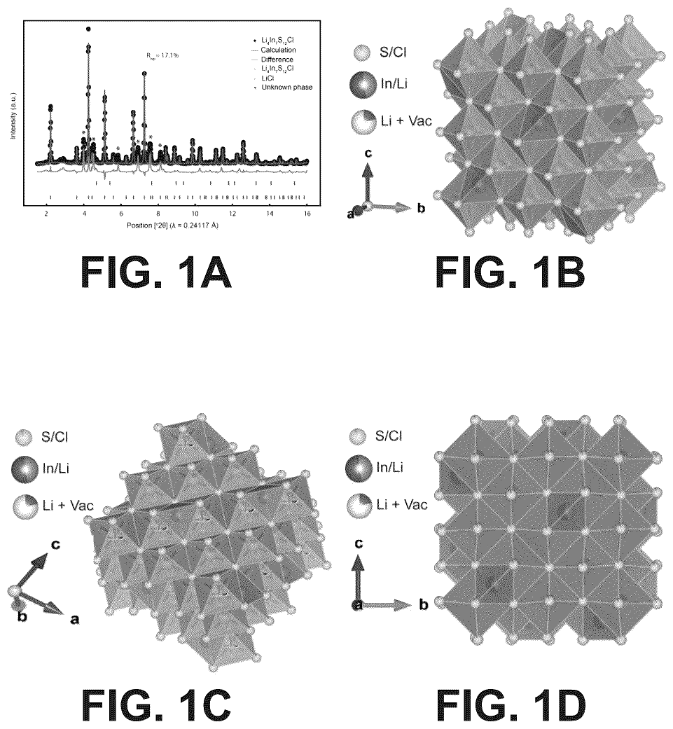

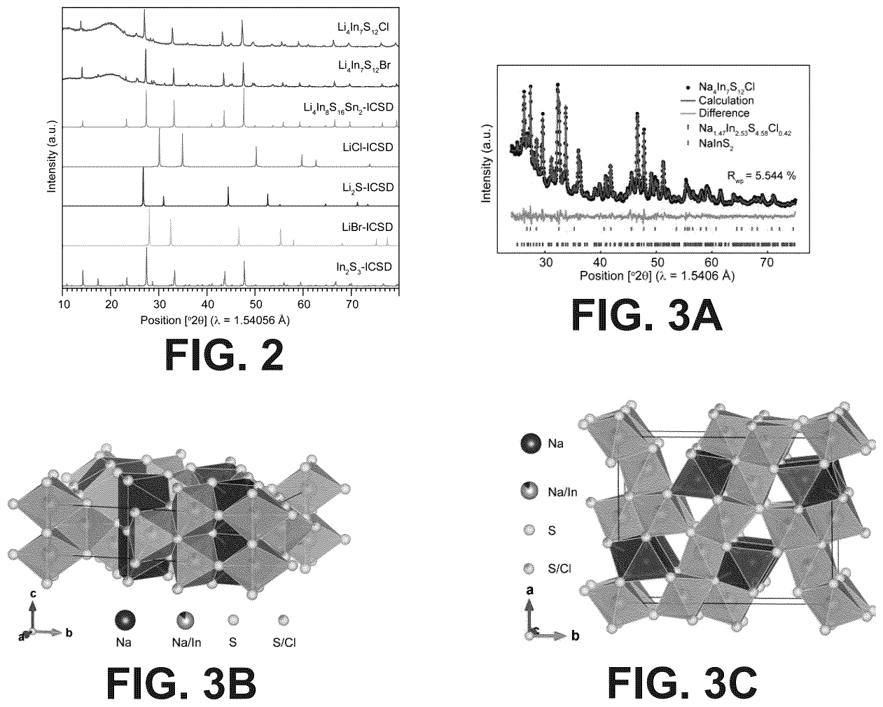

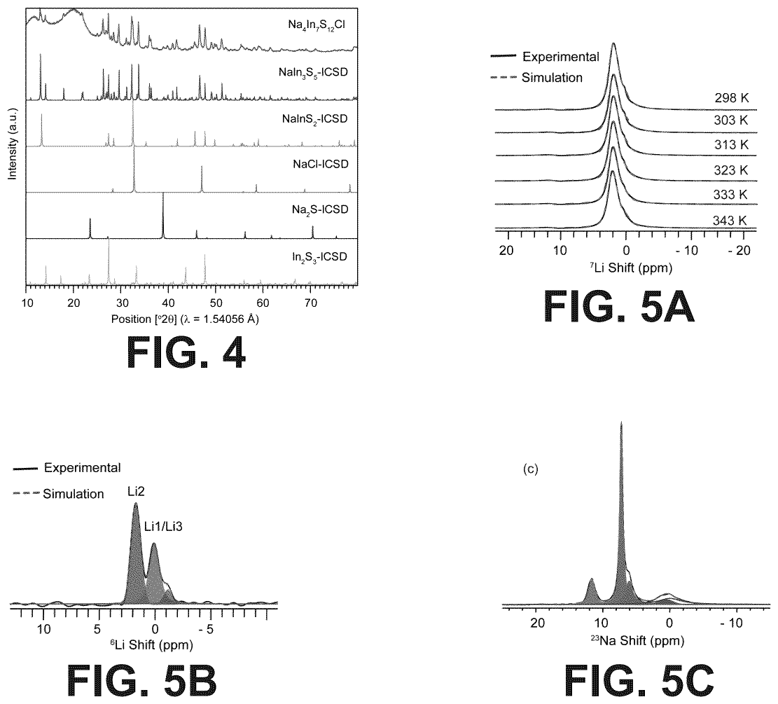

Structure—Li₄In₇S₁₂Cl (LISC) and Na₄In₇S₁₂Cl (NISC) were synthesized via the classical solid-state route (see Materials and Methods). FIGS. 2 and 4 show the room temperature XRD pattern, with the patterns of the precursors shown for comparison. Structural refinement with GSAS-II reveals that LISC crystallizes in the Fd-3m space group (cubic crystal system) with lattice parameters a=b=c=10.7794 Å and V=1252.5167 Å³. Notably, LISC and Li₄In₈S₁₆Sn₂ (LISS) crystallize in the same space group with similar diffraction pattern, therefore structural refinement of the LISC synchrotron data was performed using LISS as the model phase. Different orientations of the crystal structure of LISC are also shown in FIG. 1. Li1 shares the 16d Wyckoff position with In2. This octahedral site is not fully occupied by Li1 and In2 and has a vacancy of 0.4%. Li2 in the tetrahedral site shares the 8a Wyckoff position with In1. The tetrahedral site is also not fully occupied—possessing a 1.5% vacancy. Li3 occupies the 16c Wyckoff position in the octahedral site with no cation mixing (Li-rich channel). Li3 only has a 22% occupancy, thereby leaving an 88% vacancy in this octahedral site that is beneficial for ion transport. The unoccupied octahedral sites can be partially filled by Li ions as they undergo diffusion, resulting in a higher mobile concentration of ionic charge carriers.¹ Li1 in the octahedral site is edge-sharing with Li2 in the tetrahedral site which also shares an edge with another Li1 in the octahedral site. This creates an Oct-Tet-Oct pathway (Li1-Li2-Li1) for lithium-ion transport. Moreover, octahedral lithium (Li1) is edge-sharing with the octahedral lithium (Li3), giving rise to an Oct-Oct migration pathway (Li1-Li3).

Recent studies have juxtaposed the role of anion charge, site distortion, and site/polyhedron volume on migration barrier and preferred occupancy for Li⁺ within the anion sublattice.^{2,3} With larger polyhedral volume, the relative energy of tetrahedral site (Eₜₑₜ) becomes lower than that of octahedral (E_{oct}). As a result, the tetrahedral site is expected to have more Li occupancy. However, with increasing anion charge (owing to the higher electronegativity of Cl⁻ in the mixed S/CI site), the migration energy for lithium ions in the tetrahedral site becomes higher, such that the Oct-Oct pathway for the octahedral Li⁺ may become more preferred due to its lower migration barrier.¹⁻³ The synchrotron powder XRD pattern, structure and refined pattern of LISC is shown in FIG. 1.

Structural refinement with GSAS-II reveals that NISC crystallizes in the Pbam space group with refined lattice parameters a=12.50517 Å, b=16.11533 Å, c=3.80123 Å and V=766.042783 Å³. Different orientations of the crystal structure of NISC are shown in FIGS. 3B and 3C. Na1 fully occupies the 4g Wyckoff position in the pentagonal bipyramid polyhedra and is 7-fold coordinated by distinct sulfur atoms and mixed sulfur/chlorine atoms in asymmetric positions. The remaining sodium atoms are distributed over 4 Wyckoff positions: 2a, 4h, 4g and 2d, sharing crystallographic sites with In1, In2, In3 and In4, respectively. The mixed Na/In occupy the distorted octahedral sites. Na5 occupying the 2d Wyckoff position is 6-fold coordinated by randomly distributed sulphur and chlorine atoms. Na2 that occupies the 2a Wyckoff position shows a slightly distorted octahedra coordinated by only sulfur atoms. In the 4h Wyckoff position, Na3 shows a greater degree of distortion and is coordinated by 2 mixed sulfur/chlorine atoms and 4 distinct sulfur atoms. However, Na4 occupying the 4g Wyckoff position occupies a near perfect octahedra coordinated by 3 mixed sulfur/chlorine atoms and 3 distinct sulfur atoms. Na1 occupying the bipyramidal site is edge-sharing with Na3, Na2, Na5 and shares corner with Na4. The edge-sharing and corner-sharing polyhedral connections between the sodium sites creates an over-coordinated Na site, which destabilizes the Nat and enhances their mobility.⁴ Specifically, this leads to more connected pathways for Na⁺ diffusion due to lowering of the energy barrier⁴ With this corner sharing framework, there is distortion of the Na site that allows for a frustrated energy landscape.^{3, 5} In addition, the large degree of anion site disorder on the polyhedra further enhances the migration entropy.^{3, 6} The powder XRD pattern, structure and refined pattern of NISC is shown in FIG. 3.

Solid-state NMR—High resolution ⁶Li NMR is used to determine the local structure of potential chemical phases formed in LISC. FIG. 5B shows the ⁶Li NMR of LISC. The resonance at 0.10 ppm (Li1/Li3) and 1.75 ppm (Li2) is assigned to two different major Li⁺ sites, respectively.⁷ The assignments are in correlation with the Li-occupancy determined from the diffraction results. The relative integral of the resonance at 0.1 ppm equals the sum of the Li-occupancy for Li1 and Li3. Two distinct peaks are most likely not observable for the Li1 and Li3 sites due to fast Li⁺ hopping between the two octahedral sites, which causes a motionally averaged NMR signal^{7, 8}. The lower resonance frequency of Li1/Li3 could arise from polyhedral distortion present at the octahedral sites due to the higher number of vacancies.⁹ The resonance at −1.1 ppm is attributed to a slight impurity, LiCl.^{10 7}Li NMR relaxometry was utilized to study Li⁺-ion mobility in LISC (FIG. 5A) According to the Bloembergen, Purcell, and Pound (BPP) model, T₁ relaxation time is a function of motional rate

$$( \frac{1}{{τ}_{c}} ) .$$

In the fast-motion regime, T₁ increases with increasing motional rate (ωₒτ_{c}<1) while in the slow-motion regime, T₁ decreases with increasing motional rate (ωₒτ_{c}>1). In addition, a resonance can lie in the intermediate region where ωₒτ_{c}=1. The T₁ relaxation times for Li1/Li3 and Li2 are 1.35 s and 15.03 s, respectively. From variable-temperature T1 relaxation measurements, the T₁ relaxation time decreases with increasing temperature for all the resonances. The shorter T₁ with increasing temperature suggests all Li sites lie in the slow-motion regime. Therefore, a shorter T₁ value will correlate with faster ion mobility. Consequently, the Li1/Li3 site most likely contributes Li⁺ ion motion as the relaxation time is significantly shorter than Li2. In addition, the ⁷Li NMR line width is narrower compared to the Li2 site and exhibits an overall shorter T₁ relaxation time. A narrower line width suggests weaker dipolar interactions that might arise from free Li⁺ species with high mobility. The line widths of Li1/Li3 and Li2 are 211.05 Hz and 229.43 Hz.

In addition, the local structural environments of Na ions were also probed using solid-state NMR. FIG. 5C displays the room-temperature ²³Na MAS NMR spectrum of NISC. The spectrum displays five resonances at 11.69, 7.25, 6.14, 0.67, and 0.04 ppm. Each resonance corresponds to 5 distinctive sodium sites in the NISC crystal structure, which is also confirmed from the diffraction results. The resonance at 6.14 ppm and 7.20 ppm are attributed to the Na1 and Na4 sites. Both these sites are corner shared and occupy the 4g Wyckoff position, thus expected to be near neighbors. The Na1 is assigned to a lower frequency resonance due to its higher 7-fold coordination in the pentagonal bipyramid polyhedral. In comparison, the Na4 is a near perfect octahedra which should exhibit high symmetry. The highly symmetrical and sharp line shape of the peak at 7.20 ppm is an indication of a highly symmetric site. ^{11, 12} Therefore, due to the higher coordination and asymmetry of the Na1 site is expected to have a higher surrounding electron density, shifting the resonance towards lower ppm.^{7, 13} The higher electron density arises to further distortion to the other Na-sites, inducing the over-coordinated Na site and destabilizing the Na-ions for enhanced mobility. The Na2, Na3, and Na5 site are assigned at 11.69, 0.04, and 0.67 ppm. The assignments are based on the level of distortion between the mixed Na/In octahedral sites. The higher shift for the Na2 indicates the structural site being closer to a more uniform anion distribution, which sulfur is not being replaced by CI. The Na3 and Na5 site exhibit line widths much broader compared to the other sites. The line widths of the Na1, Na2, Na3, Na4, and Na5 are as follows—156, 151.42, 550.22, 71, and 317 Hz. The broader line shape for Na3 and Na5 indicates a higher level of bond length distortion which could arise from the random and/or mixed bonding to sulfur/chlorine atoms.^{12, 14}

The relaxation times for all the peaks are in the magnitude of seconds. Therefore, the NMR relaxation is assumed to be driven by the typical T₁ relaxation time and dipolar couplings and not from quadrupolar effects. ¹⁵ The T₁ relaxation times are shown in Table 1. The Na2 site exhibits the shortest relaxation time of 0.55 s. This is an indication that the Na-ion mobility is faster at the Na2 site compared to the other Na sites. This is most likely due to higher repulsion of Na⁺—Na⁺ ions at the Na2 site. The higher frequency shift of Na2 indicates the Na bond length is lower compared to the other sites. This enables shorter distances for Na-ion migration and higher Na⁺ ion repulsion, lowering the energy barrier for ion transport.¹⁶ Furthermore, the anion site disorder and bond length distortion from Na1, Na3, and Na5, creates local distortion within the framework which causes higher attraction between Na+-S²⁻/Cl⁻ ions. This causes the Na occupying these sites to be more stabilized and thus less mobile in comparison to the Na2 site.

TABLE 1
Chemical Shift and T₁ Relaxation Time for ²³Na NMR of NISC.

| Na site | Shift (ppm) | T₁ Relaxation Time |
|---|---|---|
| Na1 | 6.14 | 1.17 |
| Na2 | 11.69 | 0.55 |
| Na3 | 0.04 | 1.98 |
| Na4 | 7.20 | 9.05 |
| Na5 | 0.67 | 1.62 |

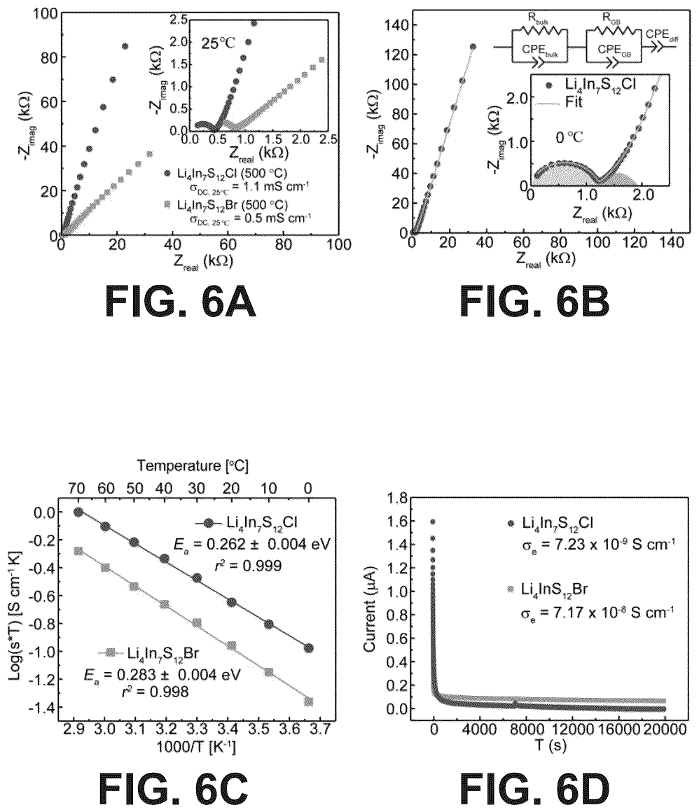

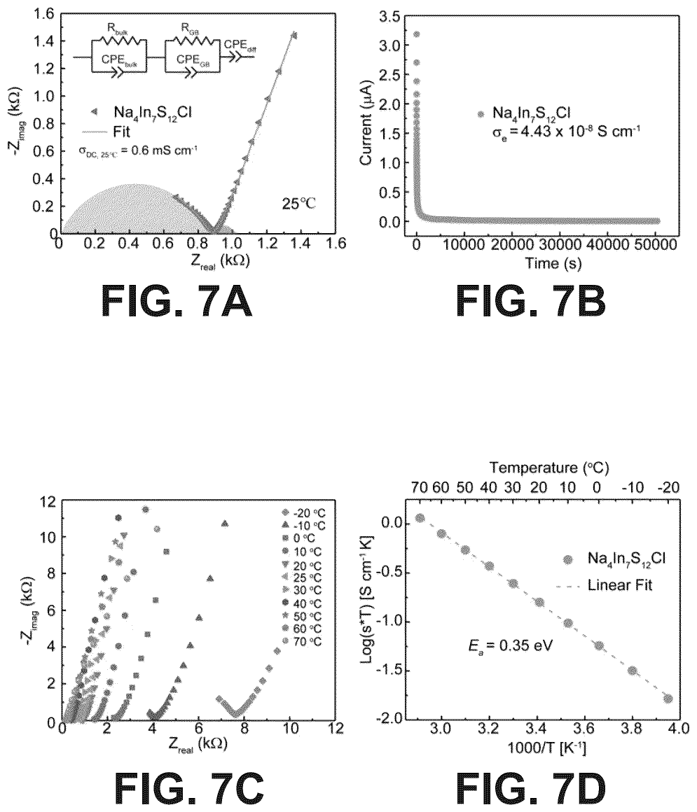

Electrochemical Properties—AC impedance spectroscopy was utilized to determine the ionic conductivity of LISC, LISB, and NISC. While grain boundaries in sulfide materials are commonly assumed to exert a negligible influence on total ion conductivity, studies have demonstrated a significant impact, often exceeding an order of magnitude.¹⁷ To deconvolute into the distinct contributions of grain and grain boundary processes, room- and low-temperature EIS measurements were conducted. The Nyquist plots (FIGS. 6A and 6B) reveal bulk and grain boundary contribution as evident from equivalent circuit fitting parallel circuit integrating two resistors (R_{bulk} and R_{GB}) in parallel with a constant phase element (CPE) representing ion transport. This arrangement is in series with another CPE representing the ion-blocking electrodes. Similar contributions from bulk and grain boundary has been reported for Li₆B₇S₁₃₁I.¹⁸ LISC attains a conductivity of 1.1 mS/cm⁻¹ which is significantly higher than 0.55 mS/cm and 0.60 mS/cm achieved for LISB and NISC respectively. FIGS. 6C and 7C depict the Arrhenius plots of LISC, LISB, and NISC. An energy barrier (Eₐ) of 0.26, 0.28, and 0.35 eV respectively were determined from the linear fit of the Arrhenius plot.

The absence of any discontinuity throughout this temperature range, along with the observed linear Arrhenius behavior, indicates the stability of the phase.¹⁸ This value falls within the broad range reported for other materials; specifically, for Li_{7.5}B₁₀S₁₈X_{1.5}, the reported activation energies are 0.36, 0.33, and 0.30 eV where X=Cl, Br, and I respectively.¹⁹ Similarly, the activation energy compares with those reported for Li₆B₇S₁₃I and Na₃B₅S₉ with 0.30 and 0.39 eV respectively.^{18, 20} The electronic conductivity was determined by DC polarization method.^{18, 20} The electronic conductivity of LISC, LISB, and NISC were determined to be 7.23×10⁻⁹, 7.17×10⁻⁸, and 4.43×10⁻⁸ S cm⁻¹ (FIGS. 6C and 7B). The relatively low electronic conductivity indicates that the overall ionic conductivity is not strongly correlated with electronic contributions.

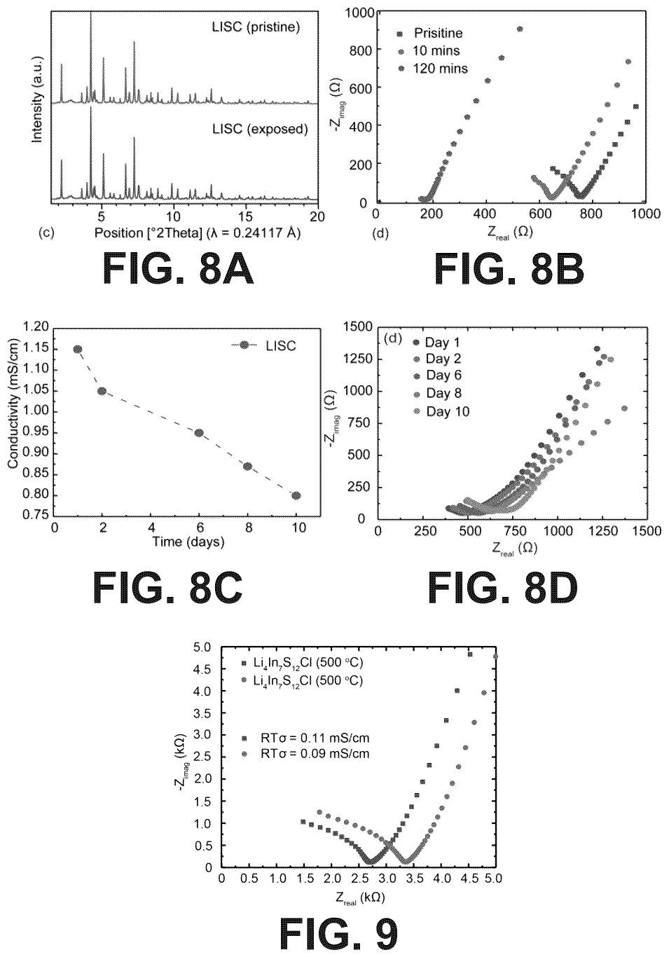

Stability Test—Recently, it has been shown that by exposing solid electrolyte to moisture, water could be incorporated into the host structure. As a consequence, the incorporated water could trigger multi-ion conduction owing to ion solvation in the electrolyte that lowers the bulk or grain boundary resistance ²¹. The stability of LISC was tested in humid air (˜35% relative humidity) over different time intervals using electrochemical impedance spectroscopy. FIG. 8B shows the Nyquist plot of the electrolyte at different exposure time. The total impedance of LISC decreases with an increase in exposure time, reaching a total ionic conductivity of 4.91 mS/cm from an initial conductivity of 1.09 mS/cm at room temperature. The diffraction peaks of the pristine and exposed LISC are shown in FIG. 8A. On exposure to humid air for 2 hours, the pristine LISC shows good air and moisture stability with no additional peak formed. In addition, there was no peak broadening or decrease in relative intensity of the peaks which suggests that LISC retains its crystallinity.

### Example 2

### Materials and Methods

### Material Synthesis

LiCl (Sigma Aldrich) and LiBr (Sigma Aldrich) were dried under vacuum at 200° C. for 12 hours before synthesis. Li₂S (Alfa Aesar) and In₂S₃ (Sigma Aldrich) were received and used without further purification. Stoichiometric amounts of Li₂S, In₂S₃, and LiCl were ground using an agate mortar and pestle in a Li:In:S:Cl molar ratio of 4:7:12:1 for 5 minutes. After grinding, the hand-milled powder was transferred into a ZrO₂ jar containing two 10-mm balls as a grinding aid. Mechanochemical mixing of the hand-milled powder in a ZrO₂ jar sealed under a vacuum was performed using a SPEX® 8000M MIXER/MILL high energy ball mill (SPEX® SamplePrep, USA) for 5 hours. Afterward, the ball-milled powder, typically 100 mg-200 mg, was pressed into a 6-mm pellet under pressure of ˜400 MPa inside an Argon-filled glovebox. The pellet was transferred into a quartz tube and sintered at 500° C. for 12 hours with a temperature ramping rate of 5° C./min, followed by natural cooling under Argon. The resulting pellet had a thickness varying from ˜1 mm to 2 mm, and the pellet appeared light yellow.

### Structural Characterization

Powder X-ray Diffraction—The sintered pellet was finely grounded and packed in a zero-background sample holder. KAPTON® film (DUPONT™, USA) was used to seal the samples to prevent exposure to humid air. XRD was performed using a RIGAKU® D8 powder diffractometer with Bragg-Brentano geometry at a voltage of 45 kV and current of 40 mA with Cu—Ka radiation (a=1.5406 Å). The data was collected within a 20 range of 10-80° at a step size of 0.03° for 30 minutes.

Synchrotron X-ray Diffraction—Synchrotron X-ray diffraction (XRD) was measured in capillary transmission mode at the 17-BM-B beamline, APS, Argonne National Lab, Illinois. The exact X-ray wavelength was refined to 0.24117 A. The sample was loaded inside a special glass capillary, and the holder moved up and down during tests to ensure uniformity of measured results. Rietveld refinement of the XRD data was performed using GSAS-II.

Scanning Electron Microscopy—The morphology of the solid electrolytes was examined using a digital scanning electron microscope (JEOL 5900) coupled with energy-dispersive X-ray spectroscopy.

Solid-state NMR—⁶Li and ⁷Li magic-angle-spinning (MAS) NMR experiments were performed using a Bruker Avance-III 500 spectrometer at Larmor frequencies of 73.6 MHz and 194.4 MHZ, respectively. The MAS rate was 25 kHz. For ⁶Li and ⁷Li, single-pulse NMR experiments were performed using TT/2 pulse lengths of 3.30 μs and 2.90 μs, respectively. The recycle delays were 500 s for ⁶Li and 80 s for ⁷Li. ^{6.7}Li NMR spectra were calibrated to LiCl₍ₛ₎ at −1.1 ppm. ⁷Li T₁ relaxation time was measured with an inversion-recovery pulse sequence. Variable-temperature in-situ ⁷Li NMR experiments were performed using a Bruker Avance III 300 spectrometer at a Larmor frequency of 116.6 MHz from 298 to 343 K. ¹H NMR experiments were performed using a Bruker Avance-III 500 spectrometer. Adamantane with a ¹H NMR peak at 1.83 ppm was used as the calibration standard.

Thermogravimetric Analysis—Differential scanning calorimetry (DSC) and thermogravimetric analysis (TGA) were performed on SDT Q600 (TA Instruments) at a heating rate of 5° C./min. Argon, with a flow rate of 100 mL/min, was used as the purge gas.

### Calculations

Density Functional Theory Calculations—Density function theory (DFT) energy calculations and Ab Initio Molecular Dynamics (AIMD) simulations were conducted using the Vienna ab initio simulation package (VASP) and the projector augmented wave (PAW) approach.^{18, 19} Perdew-Burke-Ernzerhof generalized gradient approximation (GGA-PBE) was employed as the exchange-correlation functional.²⁰ The most recent pseudopotential files provided by VASP were used. For Li₉In_{17.5}S_{29.5}Cl_{2.5}, Python Materials Genomics (Pymatgen)²¹ was employed to pre-screen the structures with different Li⁺/vacancy, Li⁺/In³⁺, and S²⁻/Cl⁻ orderings based on the experimentally refined crystal structure of Li₉In_{17.5}S_{29.5}Cl_{2.5}. A handful of 1×1×1 supercells were generated. Electrostatic energy calculations for these generated supercells were carried out using Ewald summation techniques.²² Geometry optimization was performed using DFT calculations. The AIMD simulation for Li₉In_{17.5}S_{29.5}Cl_{2.5} was performed on the relaxed structure, using the canonical ensemble for 80 ps with a step time of 2 fs at a temperature of 900 K.

NMR Calculations—Geometry relaxation and NMR chemical shielding computations were performed using plane-wave density functional theory (DFT) via the Cambridge Serial Total Energy Package (CASTEP, v. 21.11),^{23, 24} which incorporates periodic boundary conditions within the pseudopotential approximation. The Perdew-Burke-Ernzerhof (PBE) exchange-correlation functional within the generalized-gradient approximation (GGA)²⁰ was utilized. A plane-wave basis set was truncated at a cutoff energy of 700 eV with a 4×3×4 k-point grid and on-the-fly-generated pseudopotentials. Atomic positions and lattice parameters were fully optimized using the Limited-memory Broyden-Fletcher-Goldfarb-Shanno (LBFGS) algorithm^{25, 26} until the forces were less than 0.1 eV/Å. For NMR chemical shielding calculations, a cutoff energy of 800 eV and a 4×3×4 k-point grid with on-the-fly-generated pseudopotentials were employed.

Bond Valence Site Energy Calculations—The softBV-v131 algorithm^{27,28} was employed to compute the bond valence site energy (BVSE). Adjustments were made to the occupancies of mixed sites to address the challenges posed by mixed cation occupancy. Specifically, Li and In were removed from the 16d and 8a sites, respectively, to allow for Li occupancy at the 8a and In occupancy at the 16d site while accounting for stoichiometric ratios and charge neutrality. This approach allowed for accurately evaluating lithium diffusion pathways within structures demonstrating site disorder.

### Electrochemical Measurements

Electrochemical Impedance Spectroscopy (EIS)—The sintered pellets were sandwiched between indium foils in a 6 mm cylindrical cell, and the potentiostatic EIS measurement was performed using a Gamry electrochemical analyzer. The ionic conductivity was determined using the resultant impedance from the equivalent circuit fitting of the Nyquist plots. Biologic SP-300 was utilized for variable-temperature EIS (VT-EIS) measurements in the CSZ microclimate chamber. The activation energy was calculated from the Arrhenius-type plots of the VT-EIS measurements. Electronic conductivity was measured using the DC polarization method.

### Results and Discussion

### Structure

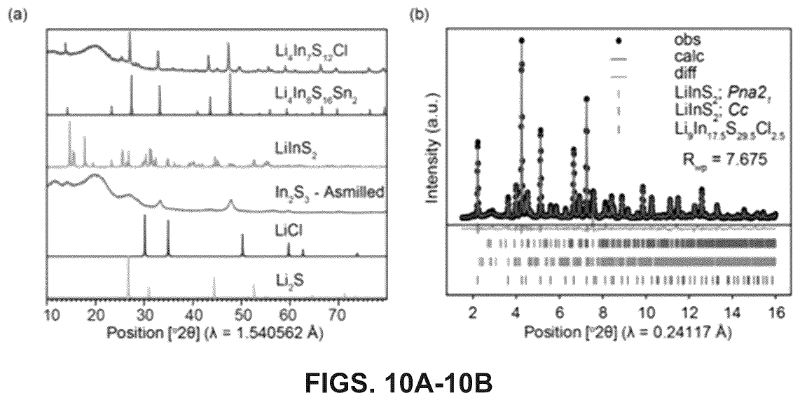

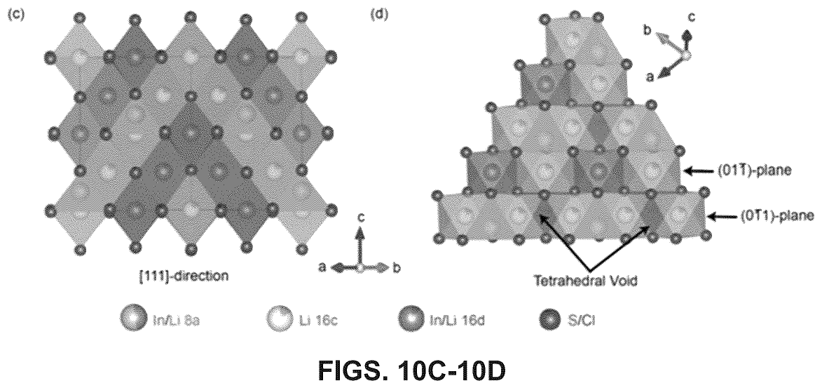

We utilized solid-state reactions to synthesize Li₄In₇S₁₂Cl (see Experimental section for details). The phase purity was initially determined with X-ray powder diffraction, and the resulting pattern is shown in FIG. 10a. Notably, our pattern displays Bragg reflections that closely match that of Li₄In₈S₁₆Sn₂.²⁹ For precise determination of bulk structural parameters, including atomic coordinates, site occupancies, and thermal parameters of Li₄In₇S₁₂Cl, a high-resolution X-ray diffraction pattern was collected at the synchrotron beamline at APS (see Experimental section for details). All Bragg peaks were indexed to the Fd-3m space group (FIG. 10b). Rietveld refinement was employed for structural and phase determination, and the refinement results are provided in Table 2. Rietveld refinement revealed Li₉In_{17.5}S_{29.5}Cl_{2.5} as the actual composition, with a trace LiInS₂ impurity. This refined composition, Li₉In_{17.5}S_{29.5}Cl_{2.5}, will be used hereafter. Li₉I_{17.5}S_{29.5}Cl_{2.5}, like other spinels, features a face-centered cubic (fcc) arrangement of S²⁻/Cl⁻ anions stabilized by interstitial cations. The anions form a cubic close-packed (ccp) lattice, while the cations are positioned in defined interstitial sites. The cations are located at 8a, 16c, and 16d sites, while anions occupy the 32e positions. 30, 31 Specifically, the unit cell of Li₉In_{17.5}S_{29.5}Cl_{2.5} consists of one tetrahedrally coordinated 8a and two octahedrally coordinated 16c and 16d lithium sites, denoted as Li₈ₐ, Li_{16c}, and Li_{16d}, respectively. Sulfur and chlorine atoms co-occupy the 32e anionic site, yielding a disordered anion sublattice (FIG. 10c).

TABLE 2
Rietveld-refinement results of high-resolution X-ray diffraction data for Li₄In₇S₁₂Cl.
Refined composition: Li₉In_{17.5}S_{29.5}Cl_{2.5}
Lattice parameter: a = b = c = 10.78014(5), α = β = γ = 90.000, Unit-cell volume = 1252.776(7) Å³
Density of Li₉In_{17.5}S_{29.5}Cl_{2.5} = 4.127 g/cm³
R_{wp} = 7.675%, Space group Fd-3m, Impurity phase: 6.6 wt % of LiInS₂

| | | Wycoff | Atomic coordinates | | | | |
|---|---|---|---|---|---|---|---|
| Name | Atom | position | x | y | z | Occupancy | Uᵢₛₒ |
| Li1 | Li | 8a | 0.125 | 0.125 | 0.125 | 0.540(3) | 0.017(4) |
| Li2 | Li | 16c | 0 | 0 | 0 | 0.161(5) | 0.016(3) |
| Li3 | Li | 16d | 0.5 | 0.5 | 0.5 | 0.132(4) | 0.016(4) |
| In1 | In | 8a | 0.125 | 0.125 | 0.125 | 0.460(3) | 0.017(4) |
| In2 | In | 16d | 0.5 | 0.5 | 0.5 | 0.868(4) | 0.016(4) |
| S1 | S | 32e | 0.258(3) | 0.258(3) | 0.258(4) | 0.962(3) | 0.022(2) |
| Cl1 | Cl | 32e | 0.258(3) | 0.258(3) | 0.258(4) | 0.074(3) | 0.022(2) |

The structure exhibits two distinct planes (FIG. 10d): (01̅1) and (011̅). The (01̅1)-plane features a 3D framework consisting of three edge-sharing 16c octahedra that face share with 8a tetrahedra. In addition, Li_{16c} octahedra face-shares with interstitial tetrahedral voids, which provide additional lithium transport pathways. The (011̅)-plane contains edge-sharing Li_{16c} and Li_{16d} octahedra. With Li occupying 13.2% and In occupying 86.8% of the 16d octahedra, Li-ion transport within this layer becomes less favorable owing to channel blocking and lower anion polarizability that arises from the presence of higher amount of multivalent (M³⁺) cation within its neighborhood.

### Local Structure and Ion Dynamics Characterized Using NMR.

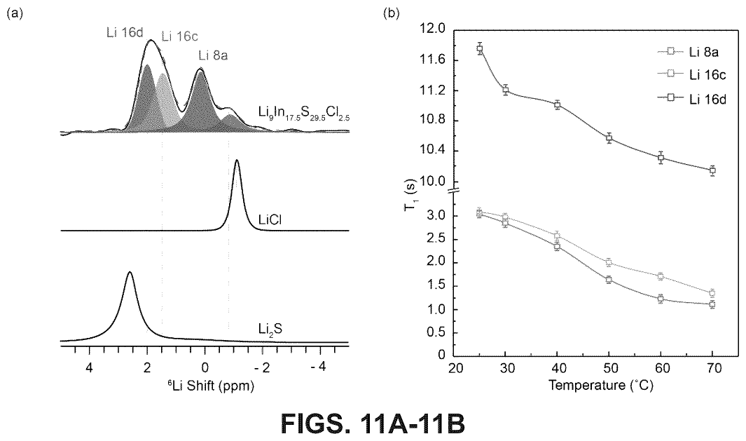

High-resolution ⁶Li NMR spectroscopy was utilized to probe the local Li⁺ environments in Li₉In_{17.5}S_{29.5}Cl_{2.5}, and four major resonances were observed (FIG. 11a). The resonance at 0.17 ppm is assigned to Lisa. The resonances at 1.49 ppm and 2.03 ppm are assigned to Li_{16c} and Li_{16d}, respectively. These assignments correlate with the Li-occupancy determined from the diffraction results. The weak resonance at −0.84 ppm is attributed to a minor impurity phase, LiInS₂. This assignment was validated with DFT NMR calculations on LiInS₂, confirming a resonance at −0.8 ppm (Table 3). The quantification from ⁶Li NMR area integrals is shown in Table 4.

TABLE 3
⁶Li NMR shift, calculated using CASTEP.

| Sample | Chemical Shift [ppm] | η | C_{q} (MHz) |
|---|---|---|---|
| LiInS₂ | −0.8 | 0.58 | −0.05 |

TABLE 4
Li (%) distribution in various components in
Li₉In_{17.5}S_{29.5}Cl_{2.5} from ⁶Li NMR analysis.

⁶Li (%)

| Sample | Li8a | Li16c | Li16d | Impurity |
|---|---|---|---|---|
| Li₉In_{17.5}S_{29.5}Cl_{2.5} (AP) | 37.4 | 29.1 | 24.5 | 9.00 |
| Li₉In_{17.5}S_{29.5}Cl_{2.5} (E) | 31.9 | 32.0 | 22.3 | 13.8 |

⁷Li NMR relaxometry was utilized to study Li⁺-ion mobility in Li₉I_{17.5}S_{29.5}Cl_{2.5}. As shown in Table 5 and FIG. 11b, the ⁷Li T₁ relaxation time is significantly shorter for Li_{16c} (3.1 s) and Li₈ₐ (3.0 s), compared to Li_{16d} (11.8 s). The Bloembergen-Purcell-Pound (BPP) model³² provides a framework for understanding spin-lattice relaxation related to ion dynamics. The BPP model is described by

$$\frac{1}{{T}_{1}} = \frac{3 {γ}^{4} {ℏ}^{2}}{10 {r}_{0}^{6}} [ \frac{{τ}_{c}}{1 + {ω}_{0}^{2} {τ}_{c}^{2}} + \frac{4 {τ}_{c}}{1 + 4 {ω}_{0}^{2} {τ}_{c}^{2}} ] ,$$

where γ is the gyromagnetic ratio, ℏ is the reduced Planck's constant, r₀ is the interatomic distance, ω₀=γB₀ is the Larmor frequency, and B₀ is the external magnetic field strength. In the fast-motion regime (ωₒτ_{c}<<1), T₁ increases with increasing motional rate, while in the slow-motion regime (ωₒτ_{c}>1), T₁ decreases with increasing motional rate. A motional rate can also lie in the intermediate region where ωₒτ_{c}=1.

TABLE 5
⁷Li relaxation times of the different Li sites in as-prepared
(AP) and exposed (E) Li₉In_{17.5}S_{29.5}Cl_{2.5}

| | ⁷Li, T₁ [s] | | |
|---|---|---|---|
| Sample | Li8a | Li16c | Li16d |
| Li₉In_{17.5}S_{29.5}Cl_{2.5} (AP) | 3.0 | 3.1 | 11.8 |
| Li₉In_{17.5}S_{29.5}Cl_{2.5} (E) | 2.8 | 3.0 | 11.2 |

Variable-temperature ⁷Li T₁ NMR relaxation time measurement reveals a decrease in T₁ relaxation time with increasing temperature and thus increasing motional rates for all the resonances, indicating that Li motion lies in the slow-motion regime (ωₒτ_{c}>1).³² Therefore, a shorter T₁ value will correlate with faster ion mobility. Consequently, Li₈ₐ and Li_{16c} exhibit faster Li⁺ ion motion as the relaxation time is significantly shorter than Li_{16d}. From ⁷Li NMR line width analysis, the line width of Li₈ₐ and Li_{16c} is narrower compared to the Li_{16d}. A narrower line width may arise from Li⁺ species with high mobility that averages out homogeneous and inhomogeneous line broadening.

### Ion Conduction Properties via Electrochemical Impedance Spectroscopy (EIS)

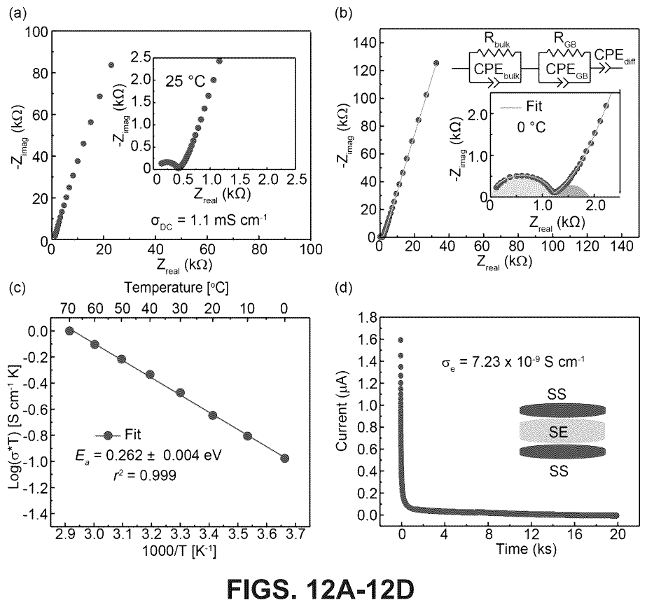

AC impedance spectroscopy was utilized to evaluate the ion transport properties of Li₉In_{17.5}S_{29.5}Cl_{2.5}. The Nyquist plot obtained at 25° C. is presented in FIG. 12a, and a representative Nyquist plot fitting of the data obtained at 0° C. using the equivalent circuit model is presented in FIG. 12b. The high-frequency semicircle with a capacitance of 0.6 pF corresponds to ion transport within the bulk of the solid electrolyte,^{33, 34} while the medium-frequency semicircle with a capacitance of 1.2 nF represents the grain boundary contribution.¹² The ionic conductivity is calculated from the bulk impedance resistance using the formula σ_{DC}=L/(R×A). Here, L represents the pellet thickness, A denotes the surface area of the blocking electrode, and R is the resistance value obtained from the equivalent circuit fitting. Based on the resistance extracted from the fitting, an ionic conductivity of 1.1 mS cm⁻¹ is obtained.

Variable-temperature EIS was carried out within the frequency range from 1 Hz to 7 MHz and the temperature range from 0° C. to 70° C. Conductivities at various temperatures were calculated based on the Nyquist plots, and the Arrhenius-type plots were prepared to calculate the activation energy. FIG. 12c depicts the Arrhenius plots of Li₉In_{17.5}S_{29.5}Cl_{2.5}. An activation energy barrier (Eₐ) of 0.26 eV was determined from the linear fit of the Arrhenius plot. This value agrees with a site energy barrier of 0.26 eV obtained from the Bond Valence Site Energy (BVSE) calculation. The absence of any discontinuity throughout this temperature range, along with the observed linear Arrhenius behavior, indicates the thermal stability of Li₉In_{17.5}S_{29.5}Cl_{2.5}.¹⁷ To verify that the conductivity arises from Li⁺ transport, the electronic conductivity of Li₉In_{17.5}S_{29.5}Cl_{2.5} was determined to be 7.23×10⁻⁹ S cm⁻¹ using the direct current (DC) polarization method at a constant voltage of 0.1 V (FIG. 12d). The relatively low electronic conductivity indicates negligible electronic contributions to the overall conductivity.

### Lithium-Ion Transport Via AIMD Simulation

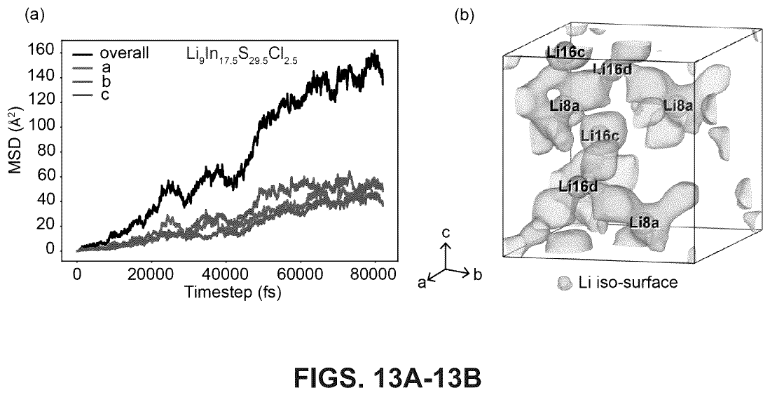

Ab initio molecular dynamics (AIMD) simulations are performed on the relaxed supercell (1×1×1) of Li₉In_{17.5}S_{29.5}Cl_{2.5}. Mean square displacements (MSD) and distribution probability of Li⁺ at 900 K are extracted from the AIMD simulations. The MSD of Li⁺ illustrates the diffusion trajectories along the a, b, and c lattice directions (FIG. 13a). Notably, the MSD of Li⁺ is similar along the a, b, and c directions, indicating a 3D diffusion pathway for Li⁺ in the Li₉In_{17.5}S_{29.5}Cl_{2.5}. FIG. 13b provides a 3D visualization of Li⁺ density distribution within the relaxed Li₉In_{17.5}S_{29.5}Cl_{2.5} crystal lattice (1×1×1), highlighting the primary lithium-ion sites labeled as Li₈ₐ, Li_{16c}, and Li_{16d}. The yellow isosurfaces represent regions of high Li⁺ probability density, indicating potential conduction pathways through the crystal lattice. This Li⁺ density map reveals a complex, interconnected lithium diffusion network, further suggesting a 3D diffusion pathway for Li⁺. These results underscore the high ionic conductivity of Li₉In_{17.5}S_{29.5}Cl_{2.5}, driven by the extensive 3D diffusion network.

Moisture-Stability of Li₉In₇S₁₂Cl

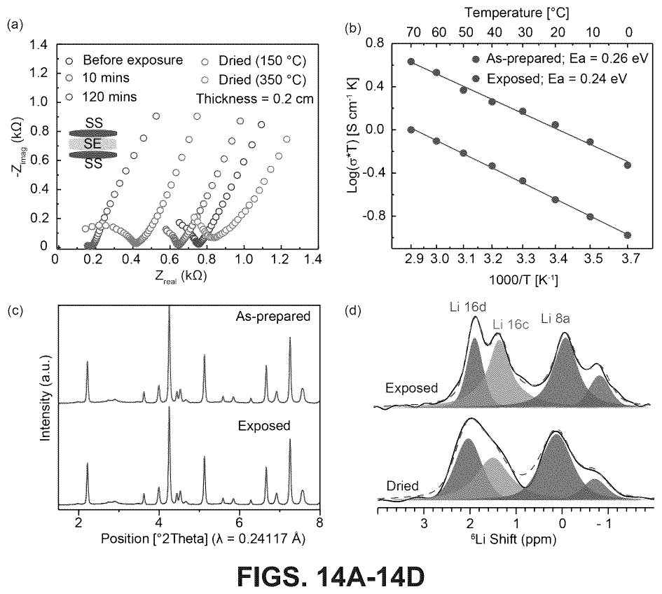

A significant challenge for large-scale production of sulfide solid electrolytes is their poor stability against atmospheric moisture. Even low levels of moisture in the environment have been reported to trigger spontaneous hydrolysis reactions, causing material degradation, compromised performance, and the release of toxic H₂S gas. 35, 36 Broadly, on exposure of solid electrolytes to moisture, decomposition products such as LiCl,³⁷⁻³⁹ Li₂S, 37, 39, 40, LiOH, 38-40 LiOH. H₂O^{36, 39}, and In₂O₃³⁸ may be formed. These compounds exhibit poor ionic conductivity and significantly increase interfacial impedance when formed on the surface of sulfide SSE particles.^{38, 40} Li₉In_{17.5}S_{29.5}Cl_{2.5} was exposed to air for 2 hours (denoted as “moisture-Exp”) to assess the impact of moisture on its average structure, short-range structure, morphology, and ionic conductivity. FIG. 14c displays the XRD patterns of Li₉In_{17.5}S_{29.5}Cl_{2.5} before and after 2 hours of exposure to humid air at room temperature. A comparison of the diffraction pattern of as-prepared and moisture-Exp samples reveals insignificant modification of the average structure. Particularly, no new peaks were formed post-exposure. This is consistent with ⁶Li NMR results of the moisture-Exp sample (FIG. 14d)—confirming the absence of LiCl, LiOH, or Li₂S, post-exposure.

The Hard-Soft Acid-Base (HSAB) theory predicts favorable interactions between soft acids (e.g., Ge⁴⁺, Sn⁴⁺, In³⁺) and soft bases (e.g., S²⁻).^{35, 41-44} These interactions lead to the formation of strong covalent bonds, potentially creating a stable framework with open channels.⁴¹ To be specific, In³⁺, classified as a soft acid, will preferentially interact with the soft base, S²⁻. ⁴⁴ This preferential bonding with sulfur prevents the harder base oxygen (present in moisture) from reacting with In³⁺ upon exposure to air or moisture. As a result, Li₉In_{17.5}S_{29.5}Cl_{2.5} exhibits improved moisture stability. A decrease in the activation energy is observed for the moisture-Exp pellet (0.24 eV) relative to the as-prepared pellet (0.26 eV) (FIG. 14b). Moreover, the corresponding impedance plot (see FIG. 14a) reveals a significant increase in ionic conductivity to 4.2 mS/cm on exposure to moisture—an observation in contrast to what has been reported for most sulfide solid electrolytes,⁴⁵⁻⁴⁷ except layered structures where H₂O intercalate between the sheets.⁴⁸

The Hard-Soft Acid-Base (HSAB) theory predicts favorable interactions between soft acids (e.g., Ge⁴⁺, Sn⁴⁺, In³⁺) and soft bases (e.g., S²⁻).^{35, 41-44} These interactions lead to the formation of strong covalent bonds, potentially creating a stable framework with open channels.⁴¹ To be specific, In³⁺, classified as a soft acid, will preferentially interact with the soft base, S²⁻.⁴⁴ This preferential bonding with sulfur prevents the harder base oxygen (present in moisture) from reacting with In³⁺ upon exposure to air or moisture. As a result, Li₉In_{17.5}S_{29.5}Cl_{2.5} exhibits improved moisture stability. A decrease in the activation energy is observed for the moisture-Exp pellet (0.24 eV) relative to the as-prepared pellet (0.26 eV) (FIG. 14b). Moreover, the corresponding impedance plot (see FIG. 14a) reveals a significant increase in ionic conductivity to 4.2 mS/cm on exposure to moisture—an observation in contrast to what has been reported for most sulfide solid electrolytes,⁴⁵⁻⁴⁷ except layered structures where H₂O intercalate between the sheets.⁴⁸

Water uptake can influence cation mobility through solvation or altering the crystallographic structure.⁴⁹ Although hydration studies on solid Li⁺ and Na⁺ conductors are limited, existing research suggests enhanced Li⁺ and Na⁺ diffusion with water adsorption.⁴⁹ The adsorbed water may exist in different forms; for instance, free water clusters and loosely and strongly bound water have been identified in Nafion.^{50.51} To understand the origin of the improved ionic conductivity of Li₉In_{17.5}S_{29.5}Cl_{2.5} post-exposure, we performed ¹H and ^{6.7}Li NMR on the as-prepared and moisture-exp samples. For the moisture-Exp sample, a peak at 4.7 ppm was observed in the ¹H NMR spectrum; in contrast, only the background resonance (empty rotor) was observed for the as-prepared sample. The resonance at ca. 4.7 ppm in moisture-exp Li₄In₇S₁₂Cl indicates that the adsorbed water is more distinctly characterized as a bulk liquid rather than surface-bound. Increased ionic conductivity in the moisture-exposed Li₉In_{17.5}S_{29.5}Cl_{2.5} is therefore attributed to ion transport facilitated by the adsorbed water.

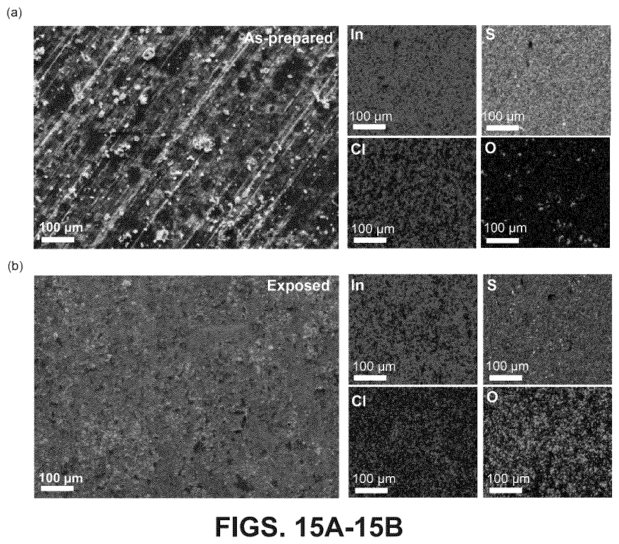

The SEM images and the EDS elemental mapping of In, S, Cl, and O for the as-prepared Li₉In_{17.5}S_{29.5}Cl_{2.5} and moisture-exposed pellet are shown in (FIGS. 15a-b). Prior to ambient exposure, the as-prepared pellet demonstrates a highly compact structure. The initial SEM image reveals an uneven surface with loose particles; however, it is devoid of major cracks. Notably, the microstructure of the moisture-exposed sample does not change significantly. However, the pellet surface is smoother. Elemental mapping of the as-prepared Li₉In_{17.5}S_{29.5}Cl_{2.5} reveals a uniform distribution of In, S, Cl, and a negligible amount of O. The negligible amount of oxygen likely results from the few seconds exposure to humid air during sample transfer into the SEM instrument. Similarly, In, S, Cl are uniformly distributed in the exposed pellet. In addition, a significant oxygen concentration is observed around the particles, likely from the adsorbed water. It is evident that the absorbed water is not disturbing the Li₉In_{17.5}S_{29.5}Cl_{2.5} structure, but rather distributes on the surfaces of the particles. The enhanced microstructural stability of Li₉In_{17.5}S_{29.5}Cl_{2.5} may be attributed to the structural stabilization from the strong covalent interaction of In³⁺ with S²⁻, effectively preventing hydrolysis reactions.¹⁵

The hydrolysis resistance of Li₉In_{17.5}S_{29.5}Cl_{2.5} was evaluated by full immersion of the solid electrolyte in deionized water. Throughout the exposure test, no significant changes were visually observed, indicating that its structure was not severely altered.⁴² Further quantitative evaluation of hydrolytic resistance was performed by comparing the mass of the electrolytes before and after immersion. The mass remains almost constant at 140 mg-only reaching 139.4 mg after 1 hour, suggesting excellent hydrolysis resistance of Li₉In_{17.5}S_{29.5}Cl_{2.5}. To simulate non-oxidative environments, thermogravimetric analysis (TGA) and differential scanning calorimetry (DSC) were performed under an inert atmosphere at a constant heating rate from 0° C. to 700° C. The initial thermal event, observed between 49° C. and 83° C., reflects dominant endothermic peaks. This corresponds to removing physiosorbed water molecules, resulting in a mass loss of 3.37%. A minor endothermic event observed at ca. 350° C. is attributed to removing bulk water buried inside Li₉In_{17.5}S_{29.5}Cl_{2.5}.⁵³ Overall, the mass loss of 3.61% is due to water removal, indicating good thermal stability of Li₉In_{17.5}S_{29.5}Cl_{2.5}.

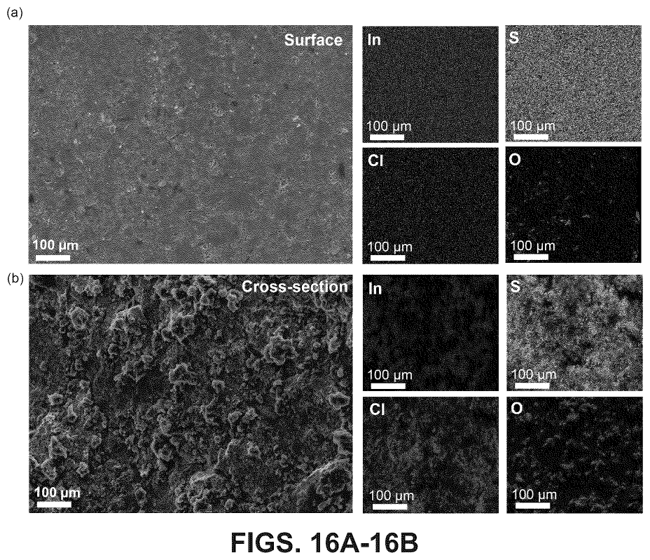

The exposed pellets were dried to investigate the impact of water removal on ion transport and structure. The impedance plot reveals a decrease in ionic conductivity (4.2 mS cm⁻¹ vs 2.06 mS cm⁻¹) of the pellet dried at 150° C. for 12 hours relative to the moisture-exposed pellet. The SEM images and the EDS elemental mapping of the surface and cross-section of the dried pellet are shown in FIGS. 16a-b. Elemental mapping reveals a minimal amount of oxygen on the surface of the dried pellet—indicating loss of surface water upon drying at 150° C. The negligible amount of oxygen may stem from water re-adsorption during sample transfer into the instrument. However, ¹H NMR reveals only a slight decrease in the intensity of the bulk water resonance—suggesting that bulk water is retained after extended heating at 150° C. for 12 hours. To confirm this observation, SEM and EDS data were collected on the cross-section of the pellet (FIG. 16b). A high amount of oxygen, evident within the cross-section, validates the presence of bulk water inside the pellet. The presence of bulk water correlates with higher ionic conductivity (FIG. 14a) of the pellet dried at 150° C. compared to the as-prepared pellet (2.06 mS cm⁻¹ vs 1.1 mS cm⁻¹).

TGA experiment suggests a thermal event at ca. 350° C.; therefore, to further examine the effect of bulk water loss on the structural stability and ionic conductivity of the moisture-exposed solid electrolyte, the pellet was dried at 350° C. The corresponding impedance plot is shown in FIG. 14a. A significant decrease in conductivity was observed (2.06 mS cm⁻¹ vs 0.98 ms cm⁻¹) relative to the pellet dried at 150° C. However, the ionic conductivity does not deviate largely from that of the as-prepared pellet (1.1 ms cm⁻¹ vs. 0.98 ms cm⁻¹), suggesting that water can be reversibly removed without compromising the structure or ion transport properties of the solid electrolyte. ¹H NMR confirms the complete removal of bulk water after drying at 350° C., further validated by significantly reduced oxygen distribution from cross-section elemental mapping of the dried pellet.

### CONCLUSION

In this study, an air- and moisture-stable solid electrolyte, Li₉In_{17.5}S_{29.5}Cl_{2.5} (space group Fd-3m), is synthesized, delivering a room-temperature ionic conductivity of 1.1 mS/cm with an activation energy of 0.26 eV. Structural characterization reveals a face-centered cubic arrangement of S²⁻/Cl⁻, stabilized by interstitial cations in a disordered anion sublattice. Notably, a 3D framework formed by tetrahedra Li₈ₐ face-sharing with octahedra Li_{16c} promotes fast Li⁺ ion diffusion, supported by AIMD simulations. ^{6.7}Li NMR and relaxometry reveal fast ion dynamics of octahedral (16c) and tetrahedral (8a) Li⁺ sites, responsible for ion transport. Li₉In_{17.5}S_{29.5}Cl_{2.5} exhibits stability against air and moisture and shows enhanced ionic conductivity to 4.2 mS/cm upon exposure, likely due to ion transport facilitated by the adsorbed water. The water can be reversely removed upon heating to 350° C. without compromising structural integrity or ion transport. The stability is attributed to the structural stabilization provided by the strong covalent bonding between In³⁺ and S²⁻.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES FOR EXAMPLE 1

1. Yang, G.; Liang, X.; Zheng, S.; Chen, H.; Zhang, W.; Li, S.; Pan, F., Li-rich channels as the material gene for facile lithium diffusion in halide solid electrolytes. eScience 2022, 2 (1), 79-86.
2. Xu, Z.; Chen, X.; Chen, R.; Li, X.; Zhu, H., Anion charge and lattice volume dependent lithium ion migration in compounds with fcc anion sublattices. npj Computational Materials 2020, 6 (1).
3. Ouyang, R.; Xu, Z.; Zhu, H., Correlated factors for Li-ion migration in ionic conductors with the fcc anion sublattice. J. Chem. Phys. 2023, 158 (17).
4. Lacivita, V.; Artrith, N.; Ceder, G., Structural and Compositional Factors That Control the Li-Ion Conductivity in LiPON Electrolytes. Chem. Mater. 2018, 30 (20), 7077-7090.
5. Jun, K.; Sun, Y.; Xiao, Y.; Zeng, Y.; Kim, R.; Kim, H.; Miara, L. J.; Im, D.; Wang, Y.; Ceder, G., Lithium superionic conductors with corner-sharing frameworks. Nat Mater 2022, 21 (8), 924-931.
6. Wood, B. C.; Varley, J. B.; Kweon, K. E.; Shea, P.; Hall, A. T.; Grieder, A.; Ward, M.; Aguirre, V. P.; Rigling, D.; Lopez Ventura, E.; Stancill, C.; Adelstein, N., Paradigms of frustration in superionic solid electrolytes. Philos Trans A Math Phys Eng Sci 2021, 379 (2211), 20190467.
7. Duff, B. B.; Elliott, S. J.; Gamon, J.; Daniels, L. M.; Rosseinsky, M. J.; Blanc, F., Toward Understanding of the Li-Ion Migration Pathways in the Lithium Aluminum Sulfides Li(3)AlS(3) and Li (4.3) AIS (3.3) CI (0.7) via (6,7) Li Solid-State Nuclear Magnetic Resonance Spectroscopy. Chem. Mater. 2023, 35 (1), 27-40.
8. MOUBTASSIM, M. L. E. O.-F., J.; SENEGAS, J.; JUMAS, J. C., Time-dependent Lithium insertion in mixed valence Tin, Indium Sulfide spinels. Tin Mossbauer Spectroscopy and Lithium NMR. Mater. Res. Bull. 1993, 28, 1083-1092.
9. Gamon, J.; Dyer, M. S.; Duff, B. B.; Vasylenko, A.; Daniels, L. M.; Zanella, M.; Gaultois, M. W.; Blanc, F.; Claridge, J. B.; Rosseinsky, M. J., Li(4.3)AlS(3.3)Cl(0.7): A Sulfide-Chloride Lithium Ion Conductor with Highly Disordered Structure and Increased Conductivity. Chem. Mater. 2021, 33 (22), 8733-8744.
10. Dupré, N.; Cuisinier, M.; Guyomard, D., Electrode/Electrolyte Interface Studies in Lithium Batteries Using NMR. The Electrochemical Society Interface 2011, 61-67.
11. Xiang, Y.; Zheng, G.; Liang, Z.; Jin, Y.; Liu, X.; Chen, S.; Zhou, K.; Zhu, J.; Lin, M.; He, H.; Wan, J.; Yu, S.; Zhong, G.; Fu, R.; Li, Y.; Yang, Y., Visualizing the growth process of sodium microstructures in sodium batteries by in-situ (23)Na MRI and NMR spectroscopy. Nat Nanotechnol 2020, 15 (10), 883-890.
12. Pecher, O.; Carretero-González, J.; Griffith, K. J.; Grey, C. P., Materials' Methods: NMR in Battery Research. Chem. Mater. 2016, 29 (1), 213-242.
13. Reif, B.; Ashbrook, S. E.; Emsley, L.; Hong, M., Solid-state NMR spectroscopy. Nat Rev Methods Primers 2021, 1.
14. Bottke, P.; Hogrefe, K.; Kohl, J.; Nakhal, S.; Wilkening, A.; Heitjans, P.; Lerch, M.; Wilkening, H. M. R., Energetically preferred Li+ ion jump processes in crystalline solids: Site-specific hopping in β-Li3VF6 as revealed by high-resolution 6Li 2D EXSY NMR. Mater. Res. Bull. 2023, 162.
15. Feng, X.; Chien, P. H.; Zhu, Z.; Chu, I. H.; Wang, P.; Immediato-Scuotto, M.; Arabzadeh, H.; Ong, S. P.; Hu, Y. Y., Studies of Functional Defects for Fast Na-lon Conduction in Na3-yPS4-xClx with a Combined Experimental and Computational Approach. Adv. Funct. Mater. 2019, 29 (9).
16. Feng, X.; Chien, P.-H.; Wang, Y.; Patel, S.; Wang, P.; Liu, H.; Immediato-Scuotto, M.; Hu, Y.-Y., Enhanced lon Conduction by Enforcing Structural Disorder in Li-Deficient Argyrodites Li6-xPS5-xCl1+x. Energy Storage Materials 2020, 30, 67-73.
17. Seino, Y.; Ota, T.; Takada, K.; Hayashi, A.; Tatsumisago, M., A sulphide lithium super ion conductor is superior to liquid ion conductors for use in rechargeable batteries. Energy Environ. Sci. 2014, 7 (2), 627-631.
18. Kaup, K.; Bishop, K.; Assoud, A.; Liu, J.; Nazar, L. F., Fast Ion-Conducting Thioboracite with a Perovskite Topology and Argyrodite-like Lithium Substructure. J. Am. Chem. Soc. 2021, 143 (18), 6952-6961.
19. Kaup, K.; Assoud, A.; Liu, J.; Nazar, L. F., Fast Li-Ion Conductivity in Superadamantanoid Lithium Thioborate Halides. Angew. Chem. Int. Ed. Engl. 2021, 60 (13), 6975-6980.
20. Zhou, L.; Bazak, J. D.; Singh, B.; Li, C.; Assoud, A.; Washton, N. M.; Murugesan, V.; Nazar, L. F., A New Sodium Thioborate Fast lon Conductor: Na(3) B(5) S(9). Angew. Chem. Int. Ed. Engl. 2023, 62 (30), e202300404.
21. Iton, Z. W. B.; Lee, B. C.; Jiang, A. Y.; Kim, S. S.; Brady, M. J.; Shaker, S.; See, K. A., Water Vapor Induced Superionic Conductivity in ZnPS(3). J. Am. Chem. Soc. 2023.

### REFERENCES FOR EXAMPLE 2

1. Yamaguchi, H.; Yao, A.; Hiroi, S.; Yamada, H.; Tseng, J.-c.; Shimono, S.; Utsuno, F.; Ohara, K., Formation process of halogen-rich argyrodite: elemental disordering of atomic arrangement at the 4a and 4d sites in a heat treatment. J. Solid State Electrochem. 2024.
2. Cho, S.; Kim, Y.; Song, Y.; Ryu, J.; Choi, K.; Yang, J.; Lee, S. H.; Im, S. G.; Park, S., Functional Polymer Thin Films for Establishing an Effective Electrode Interface in Sulfide-Based Solid-State Batteries. Adv. Funct. Mater. 2024.
3. Kim, K. H.; Lee, M. J.; Ryu, M.; Liu, T. K.; Lee, J. H.; Jung, C.; Kim, J. S.; Park, J. H., Near-strain-free anode architecture enabled by interfacial diffusion creep for initial-anode-free quasi-solid-state batteries. Nat Commun 2024, 15 (1), 3586.
4. Naik, K. G.; Chatterjee, D.; Mukherjee, P. P., Solid Electrolyte-Cathode Interface Dictates Reaction Heterogeneity and Anode Stability. ACS Appl Mater Interfaces 2022, 14 (40), 45308-45319.
5. Kim, T.; Chang, H.; Song, G.; Lee, S.; Kim, K.; Lee, S.; Moon, J.; Lee, K. T., Critical Factors Contributing to the Thermal Runaway of Thiophosphate Solid Electrolytes for All-Solid-State Batteries. Adv. Funct. Mater. 2024.
6. Wang, C.; Adair, K.; Sun, X., All-Solid-State Lithium Metal Batteries with Sulfide Electrolytes: Understanding Interfacial Ion and Electron Transport. Accounts of Materials Research 2021, 3 (1), 21-32.
7. Su, H.; Li, J.; Zhong, Y.; Liu, Y.; Gao, X.; Kuang, J.; Wang, M.; Lin, C.; Wang, X.; Tu, J., A scalable Li—Al—Cl stratified structure for stable all-solid-state lithium metal batteries. Nat Commun 2024, 15 (1), 4202.
8. Chen, S.; Xie, D.; Liu, G.; Mwizerwa, J. P.; Zhang, Q.; Zhao, Y.; Xu, X.; Yao, X., Sulfide solid electrolytes for all-solid-state lithium batteries: Structure, conductivity, stability and application. Energy Storage Materials 2018, 14, 58-74.
9. Hayashi, A.; Masuzawa, N.; Yubuchi, S.; Tsuji, F.; Hotehama, C.; Sakuda, A.; Tatsumisago, M., A sodium-ion sulfide solid electrolyte with unprecedented conductivity at room temperature. Nat Commun 2019, 10 (1), 5266.
10. Xian, C.; Wang, Q.; Xia, Y.; Cao, F.; Shen, S.; Zhang, Y.; Chen, M.; Zhong, Y.; Zhang, J.; He, X.; Xia, X.; Zhang, W.; Tu, J., Solid-State Electrolytes in Lithium-Sulfur Batteries: Latest Progresses and Prospects. Small 2023, 19 (24), e2208164.
11. Rajagopal, R.; Subramanian, Y.; Kang, S.; Park, J.; Ryu, K.-S., Improved interfacial stability of all-solid-state batteries using cation-anion co-doped glass electrolytes. Communications Materials 2024, 5 (1).
12. Hanghofer, I.; Brinek, M.; Eisbacher, S. L.; Bitschnau, B.; Volck, M.; Hennige, V.; Hanzu, I.; Rettenwander, D.; Wilkening, H. M. R., Substitutional disorder: structure and ion dynamics of the argyrodites Li(6)PS(5)Cl, Li(6)PS(5)Br and Li(6)PS(5)I. Phys. Chem. Chem. Phys. 2019, 21 (16), 8489-8507.
13. Li, W.; Liang, J.; Li, M.; Adair, K. R.; Li, X.; Hu, Y.; Xiao, Q.; Feng, R.; Li, R.; Zhang, L.; Lu, S.; Huang, H.; Zhao, S.; Sham, T.-K.; Sun, X., Unraveling the Origin of Moisture Stability of Halide Solid-State Electrolytes by In Situ and Operando Synchrotron X-ray Analytical Techniques. Chem. Mater. 2020, 32 (16), 7019-7027.
14. Jung, W. D.; Jeon, M.; Shin, S. S.; Kim, J. S.; Jung, H. G.; Kim, B. K.; Lee, J. H.; Chung, Y. C.; Kim, H., Functionalized Sulfide Solid Electrolyte with Air-Stable and Chemical-Resistant Oxysulfide Nanolayer for All-Solid-State Batteries. ACS Omega 2020, 5 (40), 26015-26022.
15. Lu, X.; Camara, O.; Liu, Z.; Windmüller, A.; Tsai, C. L.; Tempel, H.; Yu, S.; Kungl, H.; Eichel, R. A., Tuning the moisture stability of multiphase β-Li3PS4 solid electrolyte materials. Electrochemical Science Advances 2022, 3 (2).
16. Kaup, K.; Assoud, A.; Liu, J.; Nazar, L. F., Fast Li-Ion Conductivity in Superadamantanoid Lithium Thioborate Halides. Angew. Chem. Int. Ed. Engl. 2021, 60 (13), 6975-6980.
17. Kaup, K.; Bishop, K.; Assoud, A.; Liu, J.; Nazar, L. F., Fast lon-Conducting Thioboracite with a Perovskite Topology and Argyrodite-like Lithium Substructure. J. Am. Chem. Soc. 2021, 143 (18), 6952-6961.
18. Kresse, G.; Furthmuller, J., Efficient iterative schemes for ab initio total-energy calculations using a plane-wave basis set. Physical Review B 1996, 54 (16).
19. Blochl, P. E., Projector augmented-wave method. Phys Rev B Condens Matter 1994, 50 (24), 17953-17979.
20. Perdew, J. P.; Burke, K.; Ernzerhof, M., Generalized Gradient Approximation Made Simple. Phys. Rev. Lett. 1996, 77 (18), 3865-3868.
21. Ong, S. P.; Richards, W. D.; Jain, A.; Hautier, G.; Kocher, M.; Cholia, S.; Gunter, D.; Chevrier, V. L.; Persson, K. A.; Ceder, G., Python Materials Genomics (pymatgen): A robust, open-source python library for materials analysis. Computational Materials Science 2013, 68, 314-319.
22. Toukmaji, A. Y.; Board Jr, J. A., Ewald summation techniques in perspective: a survey. Computer Physics Communication 1996, 95, 73-92.
23. Clark, S. J.; Matthew, I.; Segall, D.; Pickard, C. J.; Hasnip, P. J.; Probert, M. I. J.; Refson, K.; Paynell, M. C., First Principles Methods using CASTEP. Zeitschrift für Kristallographie—Crystalline Materials 2005, 220, 567-570.
24. Segall, M. D.; Lindan, P. J. D.; Probert, M. J.; Pickard, C. J.; Hasnip, P. J.; Clark, S. J.; Payne, M. C., First-principles simulation: ideas, illustrations and the CASTEP code. J. Phys.: Condens. Matter 2002, 14, 2717-2744.
25. Liu, D. C.; Nocedal, J., On the Limited Memory BFGS Method for Large Scale Optimization Mathematical Programming 1989, 45, 503-528.
26. Nocedal, J., Updating Quasi-Newton Matrices With Limited Storage. Mathematics of Computation 1980, 35 (151), 773-782.
27. Wong, L. L.; Phuah, K. C.; Dai, R.; Chen, H.; Chew, W. S.; Adams, S., Bond Valence Pathway Analyzer—An Automatic Rapid Screening Tool for Fast Ion Conductors within softBV. Chem. Mater. 2021, 33 (2), 625-641.
28. Adams, S., From bond valence maps to energy landscapes for mobile ions in ion-conducting solids. Solid State Ionics 2006, 177 (19-25), 1625-1630.
29. Adenis, C.; Olivier-Fourcade, J.; Jumas, J.-C.; Philippot, E. J. R. d. c. m., Etude structurale par spectroscopie Mössbauer et rayons X de spinelles lacunaires de type In2S3. Revue de chimie minérale 1987, 24 (1), 10-21.
30. Zhou, L.; Kwok, C. Y.; Shyamsunder, A.; Zhang, Q.; Wu, X.; Nazar, L. F., A new halospinel superionic conductor for high-voltage all solid state lithium batteries. Energy & Environmental Science 2020, 13 (7), 2056-2063.
31. Tsurkan, V.; Krug von Nidda, H.-A.; Deisenhofer, J.; Lunkenheimer, P.; Loidl, A., On the complexity of spinels: Magnetic, electronic, and polar ground states. Physics Reports 2021, 926, 1-86.
32. Bloembergen, N.; Purcell, E. M.; Pound, R. V., Relaxation Effects in Nuclear Magnetic Resonance Absorption. Physical Review 1948, 73 (7), 679-712.
33. Poudel, T. P.; Deck, M. J.; Wang, P.; Hu, Y. Y., Transforming Li3PS4 Via Halide Incorporation: a Path to Improved Ionic Conductivity and Stability in All-Solid-State Batteries. Adv. Funct. Mater. 2023.
34. Deck, M. J.; Chien, P. H.; Poudel, T. P.; Jin, Y.; Liu, H.; Hu, Y. Y., Oxygen-Induced Structural Disruption for Improved Li+ Transport and Electrochemical Stability of Li3PS4. Advanced Energy Materials 2023, 14 (4).
35. Zhu, Y.; Mo, Y., Materials Design Principles for Air-Stable Lithium/Sodium Solid Electrolytes. Angew. Chem. Int. Ed. Engl. 2020, 59 (40), 17472-17476.
36. Sang, J.; Pan, K.; Tang, B.; Zhang, Z.; Liu, Y.; Zhou, Z., One Stone, Three Birds: An Air and Interface Stable Argyrodite Solid Electrolyte with Multifunctional Nanoshells. Adv Sci (Weinh) 2023, 10 (32), e2304117.
37. Chen, Y.-T.; Marple, M. A. T.; Tan, D. H. S.; Ham, S.-Y.; Sayahpour, B.; Li, W.-K.; Yang, H.; Lee, J. B.; Hah, H. J.; Wu, E. A.; Doux, J.-M.; Jang, J.; Ridley, P.; Cronk, A.; Deysher, G.; Chen, Z.; Meng, Y. S., Investigating dry room compatibility of sulfide solid-state electrolytes for scalable manufacturing. Journal of Materials Chemistry A 2022, 10 (13), 7155-7164.
38. Yang, M.; Chen, L.; Li, H.; Wu, F., Air/Water Stability Problems and Solutions for Lithium Batteries. Energy Material Advances 2022, 2022.
39. Morino, Y.; Sano, H.; Takahashi, T.; Miyashita, N.; Sakuda, A.; Hayashi, A., Hydrogen Components of a Sulfide-based Argyrodite-Type Solid Electrolyte after Moisture Exposure. The Journal of Physical Chemistry C 2023, 127 (28), 13616-13622.
40. Yersak, T. A.; Zhang, Y.; Hao, F.; Cai, M., Moisture Stability of Sulfide Solid-State Electrolytes. Frontiers in Energy Research 2022, 10.
41. Wang, Y.; Lu, X.; Zheng, C.; Liu, X.; Chen, Z.; Yang, W.; Lin, J.; Huang, F., Chemistry Design Towards a Stable Sulfide-Based Superionic Conductor Li(4) Cu(8) Ge(3) S(12). Angew. Chem. Int. Ed. Engl. 2019, 58 (23), 7673-7677.
42. Wang, C.; Hao, J.; Wu, J.; Shi, H.; Fan, L.; Wang, J.; Wang, Z.; Wang, Z.; Yang, L.; Gao, Y.; Yan, X.; Gu, Y., Enhanced Air Stability and Li Metal Compatibility of Li-Argyrodite Electrolytes Triggered by In2O3 Co-Doping for All-Solid-State Li Metal Batteries. Adv. Funct. Mater. 2024, 34 (18).
43. Fu, Y.; Gong, Z.; Li, D.; Liu, Y.; Zhou, X.; Yang, Y.; Jiao, Q., Zn doping for enhanced sodium-ion conductivity and air stability in Na3SbS4 solid electrolyte. Journal of Materials Science 2024, 59 (7), 3009-3017.
44. Guo, R.; Zhang, K.; Zhao, W.; Hu, Z.; Li, S.; Zhong, Y.; Yang, R.; Wang, X.; Wang, J.; Wu, C.; Bai, Y., Interfacial Challenges and Strategies toward Practical Sulfide-Based Solid-State Lithium Batteries. Energy Material Advances 2023, 4.
45. Yu, Z.; Shang, S. L.; Seo, J. H.; Wang, D.; Luo, X.; Huang, Q.; Chen, S.; Lu, J.; Li, X.; Liu, Z. K.; Wang, D., Exceptionally High Ionic Conductivity in Na(3) P(0.62) As(0.38) S(4) with Improved Moisture Stability for Solid-State Sodium-Ion Batteries. Adv. Mater. 2017, 29 (16).
46. Liang, J.; Li, X.; Wang, C.; Kim, J. T.; Yang, R.; Wang, J.; Sun, X., Current Status and Future Directions in Environmental Stability of Sulfide Solid-State Electrolytes for All-Solid-State Batteries. Energy Material Advances 2023, 4.
47. Choi, Y. E.; Park, K. H.; Kim, D. H.; Oh, D. Y.; Kwak, H. R.; Lee, Y. G.; Jung, Y. S., Coatable Li(4) SnS(4) Solid Electrolytes Prepared from Aqueous Solutions for All-Solid-State Lithium-Ion Batteries. ChemSusChem 2017, 10 (12), 2605-2611.
48. Hatz, A.-K.; Moudrakovski, I.; Bette, S.; Terban, M. W.; Etter, M.; Joos, M.; Vargas-Barbosa, N. M.; Dinnebier, R. E.; Lotsch, B. V., Fast Water-Assisted Lithium Ion Conduction in Restacked Lithium Tin Sulfide Nanosheets. Chem. Mater. 2021, 33 (18), 7337-7349.
49. Joos, M.; Schneider, C.; Münchinger, A.; Moudrakovski, I.; Usiskin, R.; Maier, J.; Lotsch, B. V., Impact of hydration on ion transport in Li2Sn2S5·xH2O. Journal of Materials Chemistry A 2021, 9 (30), 16532-16544.
50. Xu, F.; Leclerc, S.; Canet, D., NMR relaxometry study of the interaction of water with a Nafion membrane under acid, sodium, and potassium forms. Evidence of two types of bound water. J. Phys. Chem. B 2013, 117 (21), 6534-40.
51. Ludlam, G. A. H.; Gnaniah, S. J. P.; Degl'Innocenti, R.; Gupta, G.; Wain, A. J.; Lin, H., Measurement of Water Uptake and States in Nafion Membranes Using Humidity-Controlled Terahertz Time-Domain Spectroscopy. ACS Sustain Chem Eng 2024, 12 (20), 7924-7934.
52. Li, Y.; Li, J.; Cheng, J.; Xu, X.; Chen, L.; Ci, L., Enhanced Air and Electrochemical Stability of Li7P3S11—Based Solid Electrolytes Enabled by Aliovalent Substitution of SnO2. Advanced Materials Interfaces 2021, 8 (14).
53. Furusawa, H.; Konishi, R.; Mori, D.; Horino, H.; Horiba, T.; Takeda, Y.; Takada, J.; Yamamoto, O.; Imanishi, N., Biogenous iron oxide (L-BIOX) as a high capacity anode material for lithium ion batteries. Electrochim. Acta 2018, 281, 227-236.

1. A compound having the formula AₐM_{b}S_{c}X_{d}, wherein
A is Li, Na, K, or any combination thereof;
M is Al, Ga, In, or any combination thereof;
X is Cl, Br, I, or any combination thereof;
S is sulfur;
a is from about 3 to about 15;
b is from about 6 to about 20;
c is from about 11 to about 35; and
d is from about 0.5 to about 4.

2. The compound of claim 1, wherein A is Li.

3. The compound of claim 1, wherein A is Na.

4. The compound claim 1, wherein M is Al.

5. The compound of claim 1, wherein M is Ga.

6. The compound of claim 1, wherein M is In.

7. The compound of claim 1, wherein X is Cl or Br.

8. The compound of claim 1, wherein A is Li or Na, M is In, and X is Cl or Br.

9. The compound of claim 1, wherein (1) a is from 3 to 5, b is from 5 to 9, c is from 11 to 13, and d is from 0.5 to 2 or (2) a is from 10 to 12, b is from 15 to 20, c is from 28 to 32, and d is from 2 to 3.

10. The compound of claim 1, wherein the compound is AₐIn_{b}S_{c}X_{d}, wherein A is Li or Na, a is from 3 to 5, b is from 5 to 9, c is from 11 to 13, X is Cl or Br, and d is from 0.5 to 2.

11. The compound of claim 1, wherein the compound is LiₐIn_{b}S_{c}Cl_{d}, wherein a is from 10 to 12, b is from 15 to 20, c is from 28 to 32, and d is from 2 to 3.

12. The compound of claim 1, wherein the compound is one of Li₄In₇S₁₂Cl, Li₄In₇S₁₂Br, Na₄In₇S₁₂Cl, or Li₄In_{17.5}S_{29.5}Cl_{2.5}.

13. The compound of claim 1, wherein the compound has an ionic conductivity of at least 0.50 mS/cm to about 2.50 mS/cm.

14. The compound of claim 1, wherein the compound has an ionic conductivity of at least 4.00 mS/cm to about 6.00 mS/cm when exposed to humid air.

15. The compound of claim 1, wherein the compound has an electronic conductivity of about 1.00×10⁻⁷ S/cm to about 1.00×10⁻¹⁰ S/cm.

16. The compound of claim 1, wherein the compound is conductive over a temperature range of about −20° C. to about 100° C.

17. A method for making a compound having the formula AₐM_{b}S_{c}X_{d}, wherein
A is Li, Na, K, or any combination thereof;
M is Al, Ga, In, or any combination thereof;
X is Cl, Br, I, or any combination thereof;
S is sulfur;
a is from about 3 to about 15;
b is from about 6 to about 20;
c is from about 11 to about 35; and
d is from about 0.5 to about 4;
the method comprising:
(a) mixing in the solid state A₂S, M₂S₃, AX, and any combination thereof to produce a first mixture; and
(b) heating the first mixture to produce the compound.

18. A compound produced by the method of claim 17.

19. A battery comprising the compound claim 1.

20. A battery comprising the compound claim 18.
